(19) United States
(12) Patent Application Publication
(10) Pub. No.: US 2018/0157027 A1
(43) Pub. Date: Jun. 7, 2018

(54) WAVELENGTH TUNABLE INTERFERENCE FILTER, OPTICAL FILTER DEVICE, OPTICAL MODULE, AND ELECTRONIC APPARATUS

(71) Applicant: Seiko Epson Corporation, Tokyo (JP)

(72) Inventor: Koji KITAHARA, Ina (JP)

(21) Appl. No.: 15/888,374

(22) Filed: Feb. 5, 2018

Related U.S. Application Data
(63) Continuation of application No. 14/041,093, filed on Sep. 30, 2013.

(30) Foreign Application Priority Data
Oct. 1, 2012 (JP) 2012-219138

(51) Int. Cl. G02B 26/00; G01J 3/26; G01J 3/51

(52) U.S. Cl. CPC G02B 26/001; G01J 3/51; G01J 3/26

(57) ABSTRACT

A wavelength tunable interference filter includes a fixed substrate, a movable substrate facing the fixed substrate, a fixed reflective film provided on the fixed substrate, a movable reflective film provided on the movable substrate and facing the fixed reflective film with an inter-reflective film gap interposed therebetween, a first wiring electrode provided on the fixed substrate, and a first conductive member provided on the fixed substrate. The fixed reflective film is connected to the first wiring electrode through the first conductive member, and the thickness of the first conductive member is less than the thickness of the first wiring electrode.

### CROSS-REFERENCE TO RELATED APPLICATIONS

This application is a continuation of U.S. patent application Ser. No. 14/041,093, filed on Sep. 30, 2013, which claims priority to Japanese Patent Application No. 2012-219138, filed on Oct. 1, 2012, the disclosures of which are hereby expressly incorporated by reference herein in their entireties.

### BACKGROUND

### 1. Technical Field

The present invention relates to a wavelength tunable interference filter, an optical filter device, an optical module, and an electronic apparatus.

### 2. Related Art

A device that measures a spectrum using a wavelength tunable interference filter is known (for example, refer to JP-A-1-94312).

The device disclosed in JP-A-1-94312 is a variable interference device including a Fabry-Perot interference unit (wavelength tunable interference filter), in which substrates on which reflective films are provided face each other and a piezoelectric element is provided between the substrates, and a control circuit applies a voltage to the piezoelectric element. JP-A-1-94312 discloses a configuration for making the reflective film function as a driving electrode and a configuration for making the reflective film function as an electrode for electrostatic capacitance monitoring.

Incidentally, when the reflective film is made to function as a driving electrode or an electrode for electrostatic capacitance monitoring as disclosed in JP-A-1-94312, it is necessary to connect a wiring electrode to the reflective film. However, since the reflective film in the Fabry-Perot etalon needs to have transmission and reflection characteristics, it is not possible to increase the thickness of the reflective film in order to ensure the transmission characteristics. Accordingly, if the reflective film and the wiring electrode are formed in the same step using the same material, the thickness of the wiring electrode is also reduced. In this case, electrical resistance is increased.

In contrast, a configuration for connecting the wiring electrode to the reflective film using a configuration shown in FIG. 18 can be considered. FIG. 18 is a schematic diagram showing a connection portion between a reflective film and a wiring electrode in the related art. As shown in FIG. 18, by forming the wiring electrode connected to the reflective film as a separate member to increase the thickness of the wiring electrode, it is possible to reduce the electrical resistance of the wiring electrode.

Incidentally, since a reflective film in the wavelength tunable interference filter is an important factor in determining the optical characteristics, it is preferable to form the reflective film after forming an electrode or a wiring electrode in order to avoid deterioration and the like in the manufacturing stage.

However, when the reflective film is formed on the wiring electrode such that they overlap each other as shown in FIG. 18, if a difference between the thickness of the wiring electrode and the thickness of the reflective film increases, coverage of the reflective film is degraded in a stepped portion (end surface F1 in FIG. 18) between the wiring electrode and the substrate. As a result, the reflective film peels off from the wiring electrode, or a portion in which the reflective film does not adhere to the end surface F1 of the wiring electrode is generated when forming the reflective film. Accordingly, there is a problem in that the reflective film and the wiring electrode become disconnected from each other.

### SUMMARY

An advantage of some aspects of the invention is to provide a wavelength tunable interference filter capable of ensuring the electrical connection between a reflective film and a wiring electrode, an optical filter device, an optical module, and an electronic apparatus.

An aspect of the invention is directed to a wavelength tunable interference filter including: a first substrate; a second substrate facing the first substrate; a first reflective film that reflects a part of incident light and transmits the rest and that is provided on the first substrate; a second reflective film that reflects a part of incident light and transmits the rest, is provided on the second substrate, and is disposed so as to face the first reflective film; a wiring electrode provided on at least one of the first and second substrates; and a conductive member provided on one of the first and second substrates on which the wiring electrode is provided. One of the first and second reflective films, which is provided on the substrate on which the wiring electrode and the conductive member are provided, is connected to the wiring electrode through the conductive member by being laminated on the conductive member, and a thickness of the conductive member is less than a thickness of the wiring electrode.

In the wavelength tunable interference filter described above, the wiring electrode and the conductive member are provided on at least one of the first and second substrates, and the wiring electrode is connected to the reflective film through the conductive member. That is, the first reflective film and the wiring electrode are connected to each other through the conductive member when the wiring electrode is provided on the first substrate, and the second reflective film and the wiring electrode are connected to each other through the conductive member when the wiring electrode is provided on the second substrate.

In addition, the conductive member is thinner than the wiring electrode. For this reason, compared with a configuration in which the reflective film is provided on the wiring electrode as shown in FIG. 18, it is possible to improve the coverage of the reflective film and the conductive member. That is, since it is possible to suppress a disadvantage that the reflective film peels off from the conductive member or the reflective film is not formed on the end surface of the conductive member, it is possible to reduce the risk of disconnection of the conductive member and the reflective film. As a result, it is possible to improve the connection reliability.

In the wavelength tunable interference filter according to the aspect of the invention, it is preferable that the wavelength tunable interference filter further includes: a first electrode that is provided on the first substrate and that is provided outside the first reflective film in plan view when the first and second substrates are viewed from a substrate thickness direction; and a second electrode that is provided on the second substrate, is provided outside the second reflective film in the plan view, and faces the first electrode. In addition, it is preferable that the conductive member be disposed between one of the first and second electrodes, which is provided on the substrate on which the conductive member and the wiring electrode are provided, and one of the first and second reflective films, which is provided on the substrate on which the conductive member and the wiring electrode are provided, in the plan view.

In the wavelength tunable interference filter described above, the first electrode is provided on the first substrate, and the second electrode is provided on the second substrate. In such a configuration, it is possible to change the size of a gap (gap amount) between the first and second reflective films by electrostatic attraction by applying a voltage between the first and second electrodes.

In addition, in the wavelength tunable interference filter described above, when connecting the first reflective film to the wiring electrode through the conductive member, the conductive member is provided in a region between the first reflective film and the first electrode. In addition, when connecting the second reflective film to the wiring electrode through the conductive member, the conductive member is provided in a region between the second reflective film and the second electrode. In such a configuration, since a distance from the reflective film (first or second reflective film) to the conductive member can be shortened, it is possible to reduce the electrical resistance in a wiring portion from the reflective film to the conductive member.

In the wavelength tunable interference filter according to the aspect of the invention, it is preferable that the second substrate includes a movable portion, on which the second reflective film is provided, and a holding portion, which is provided outside the movable portion in plan view when the second substrate is viewed from a substrate thickness direction and which holds the movable portion so as to be movable back and forth with respect to the first substrate, and the conductive member is provided in the movable portion.

In the wavelength tunable interference filter described above, when providing the conductive member and the wiring electrode on the second substrate having a movable portion and a holding portion, the conductive member is provided in the movable portion. In such a configuration, since a distance from the reflective film to the conductive member can be shortened, it is possible to reduce the electrical resistance in a wiring portion from the reflective film to the conductive member.

In addition, when providing the conductive member in the holding portion for allowing the movable portion to move back and forth with respect to the first substrate, the bending state of the holding portion is changed by the film stress of the conductive member or the like. Accordingly, since it is difficult to displace the movable portion to the first substrate side while maintaining the parallelism of the first and second reflective films, it is desirable to select a conductive member in consideration of the film stress or the like. On the other hand, in the wavelength tunable interference filter described above, since the conductive member is provided in the movable portion, the influence of bending of the substrate due to the film stress is small. As a result, it is possible to improve the degree of freedom in selecting the conductive member.

In the wavelength tunable interference filter according to the aspect of the invention, it is preferable that the second substrate includes a movable portion, on which the second reflective film is provided, and a holding portion, which is provided outside the movable portion in plan view when the second substrate is viewed from a substrate thickness direction and which holds the movable portion so as to be movable with respect to the first substrate, and the conductive member is provided outside the holding portion of the second substrate in the plan view.

In the wavelength tunable interference filter described above, since the conductive member is provided outside the holding portion in the plan view, it is possible to further reduce the bending of the movable portion or the holding portion due to the internal stress of the conductive member. Accordingly, it is possible to displace the movable portion to the first substrate side while maintaining the parallelism of the first and second reflective films. In addition, since the influence of bending of the movable portion or the holding portion due to internal stress is very small, it is possible to further increase the degree of freedom in selecting the conductive member. As a result, the degree of freedom in design is improved.

In the wavelength tunable interference filter according to the aspect of the invention, it is preferable that the first and second reflective films are formed of a metal film or a metal alloy film and the conductive member is formed of a metal oxide film.

In the wavelength tunable interference filter described above, the first and second reflective films are formed of a metal film or a metal alloy film, and the conductive member is formed of a metal oxide film. Since the metal film or the metal alloy film has good adhesion to the metal oxide film, the reflective film and the conductive member can be made to be in close contact with each other when providing the reflective film on the conductive member. As a result, it is possible to suppress disadvantages, such as the peeling of the reflective film from the conductive member.

In the wavelength tunable interference filter according to the aspect of the invention, it is preferable that the wavelength tunable interference filter further includes a first electrode, which is provided on the first substrate and which is provided outside the first reflective film in plan view when the first and second substrates are viewed from a substrate thickness direction, and a second electrode, which is provided on the second substrate, is provided outside the second reflective film in the plan view, and faces the first electrode. In addition, it is preferable that the conductive member is formed of the same material as one of the first and second electrodes, which is provided on the substrate on which the conductive member and the wiring electrode are provided.

In the wavelength tunable interference filter described above, the conductive member may be formed of the same material as the electrode provided on the substrate on which the conductive member is disposed. For example, the conductive member connected to the first reflective film may be formed of the same material as the first electrode, and may be formed of a different material from the second electrode.

In the wavelength tunable interference filter described above, since the conductive member can be formed at the same time as when forming the first or second electrode, it is possible to improve the manufacturing efficiency.

In the wavelength tunable interference filter according to the aspect of the invention, it is preferable that the conductive member has a thickness of 15 nm to 150 nm.

In order to obtain the appropriate optical characteristics as a wavelength tunable interference filter, it is preferable that the thickness of the reflective film is about 15 nm to 80 nm. In the wavelength tunable interference filter described above, since the conductive member is formed in a thickness within the above-described range, it is possible to reduce the risk of disconnection of the reflective film satisfactorily. As a result, it is possible to improve the reliability in the wavelength tunable interference filter.

Another aspect of the invention is directed to an optical filter device including a wavelength tunable interference filter and a housing in which the wavelength tunable interference filter is housed. The wavelength tunable interference filter includes: a first substrate; a second substrate facing the first substrate; a first reflective film provided on the first substrate; a second reflective film that is provided on the second substrate and faces the first reflective film with a gap interposed therebetween; a wiring electrode provided on at least one of the first and second substrates; and a conductive member provided on one of the first and second substrates on which the wiring electrode is provided. One of the first and second reflective films, which is provided on the substrate on which the wiring electrode and the conductive member are provided, is connected to the wiring electrode through the conductive member by being laminated on the conductive member, and a thickness of the conductive member is less than a thickness of the wiring electrode.

In the optical filter device described above, the conductive member is thinner than the wiring electrode, and the reflective film and the wiring electrode are connected to each other through the conductive member. For this reason, there is no problem of disconnection as in a configuration in which a wiring electrode and a reflective film are connected to each other by covering the end of the wiring electrode with the reflective film. Accordingly, since it is possible to improve the reliability of wiring connection of the wavelength tunable interference filter, it is possible to improve the device reliability of the optical filter device.

In addition, since the wavelength tunable interference filter is housed in the housing, it is possible to protect the wavelength tunable interference filter against impact at the time of transportation, for example. In addition, it is possible to suppress the adhesion of foreign matter (for example, water droplets or charged substances) to the first or second reflective film of the wavelength tunable interference filter.

Still another aspect of the invention is directed to an optical module including: a first substrate; a second substrate facing the first substrate; a first reflective film provided on the first substrate; a second reflective film that is provided on the second substrate and faces the first reflective film with a gap interposed therebetween; a wiring electrode provided on at least one of the first and second substrates; a conductive member provided on one of the first and second substrates on which the wiring electrode is provided; and a detection unit that detects light extracted by the first and second reflective films. One of the first and second reflective films, which is provided on the substrate on which the wiring electrode and the conductive member are provided, is connected to the wiring electrode through the conductive member by being laminated on the conductive member, and a thickness of the conductive member is less than a thickness of the wiring electrode.

In the optical module described above, similar to the wavelength tunable interference filter and the optical filter device described above, the conductive member is thinner than the wiring electrode, and the reflective film and the wiring electrode are connected to each other through the conductive member. Therefore, since it is possible to improve the device reliability in the optical module, it is possible to accurately detect the amount of light using the optical module.

Yet another aspect of the invention is directed to an electronic apparatus including a wavelength tunable interference filter and a control unit that controls the wavelength tunable interference filter. The wavelength tunable interference filter includes: a first substrate; a second substrate facing the first substrate; a first reflective film provided on the first substrate; a second reflective film that is provided on the second substrate and faces the first reflective film with a gap interposed therebetween; a wiring electrode provided on at least one of the first and second substrates; and a conductive member provided on one of the first and second substrates on which the wiring electrode is provided. One of the first and second reflective films, which is provided on the substrate on which the wiring electrode and the conductive member are provided, is connected to the wiring electrode through the conductive member by being laminated on the conductive member, and a thickness of the conductive member is less than a thickness of the wiring electrode.

In the electronic apparatus described above, similar to the wavelength tunable interference filter, the optical filter device, and the optical module described above, the conductive member is thinner than the wiring electrode, and the reflective film and the wiring electrode are connected to each other through the conductive member. Therefore, since it is possible to improve the reliability of wiring connection of the wavelength tunable interference filter, it is possible to improve the device reliability in the electronic apparatus. As a result, the electronic apparatus can accurately perform various kinds of processing on the basis of light extracted by the wavelength tunable interference filter.

### BRIEF DESCRIPTION OF THE DRAWINGS

Embodiments of the invention will be described with reference to the accompanying drawings, wherein like numbers reference like elements.

FIG. 1 is a block diagram showing the schematic configuration of a spectrometer of a first embodiment of the invention.

FIG. 2 is a cross-sectional view of a wavelength tunable interference filter of the first embodiment.

FIG. 3 is a plan view when a fixed substrate of the wavelength tunable interference filter of the first embodiment is viewed from the movable substrate side.

FIG. 4 is a cross-sectional view schematically showing a connection state of a first wiring electrode and a fixed reflective film through a first conductive member in the wavelength tunable interference filter of the first embodiment.

FIG. 5 is a plan view when a movable substrate of the wavelength tunable interference filter of the first embodiment is viewed from the fixed substrate side.

FIG. 6 is a flowchart showing the manufacturing process of the wavelength tunable interference filter of the first embodiment.

FIGS. 7A to 7E are diagrams showing the state of a first glass substrate in the fixed substrate forming step of FIG. 6.

FIGS. 8A to 8E are diagrams showing the state of a second glass substrate in the movable substrate forming step of FIG. 6.

FIG. 9 is a diagram showing the state of the first and second glass substrates in the substrate bonding step of FIG. 6.

FIG. 10 is a plan view when a movable substrate of a second embodiment of the invention is viewed from the fixed substrate side.

FIG. 11 is a cross-sectional view showing the schematic configuration of an optical filter device of a third embodiment of the invention.

FIG. 12 is a cross-sectional view schematically showing a connection state of a first wiring electrode and a fixed reflective film through a first conductive member in another embodiment.

FIG. 13 is a block diagram showing an example of a colorimetric apparatus that includes an electronic apparatus according to the invention.

FIG. 14 is a schematic diagram showing an example of a gas detector that includes an electronic apparatus according to the invention.

FIG. 15 is a block diagram showing the configuration of a control system of the gas detector shown in FIG. 14.

FIG. 16 is a diagram showing the schematic configuration of a food analyzer that includes an electronic apparatus according to the invention.

FIG. 17 is a diagram showing the schematic configuration of a spectral camera that includes an electronic apparatus according to the invention.

FIG. 18 is a cross-sectional view showing the connection configuration of a reflective film and a wiring electrode in the related art.

### DESCRIPTION OF EXEMPLARY EMBODIMENTS

### First Embodiment

Hereinafter, a first embodiment of the invention will be described with reference to the accompanying drawings.

### Configuration of a Spectrometer

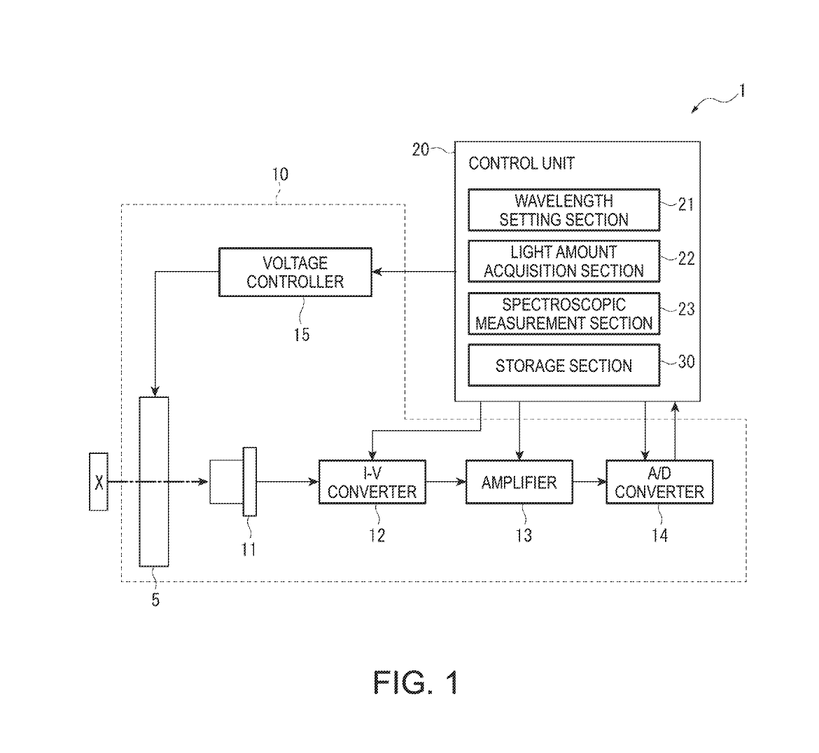

FIG. 1 is a block diagram showing the schematic configuration of a spectrometer according to the first embodiment of the invention.

A spectrometer 1 is an electronic apparatus according to the embodiment of the invention, and is an apparatus that measures a spectrum of measurement target light reflected by a measurement target X on the basis of the measurement target light. In addition, in the present embodiment, the example is shown in which the measurement target light reflected by the measurement target X is measured. However, for example, when a light emitter such as a liquid crystal panel is used as the measurement target X, light emitted from the light emitter may also be used as the measurement target light.

As shown in FIG. 1, the spectrometer 1 includes an optical module 10 and a control unit 20.

### Configuration of an Optical Module

Next, the configuration of the optical module 10 will be described below.

As shown in FIG. 1, the optical module 10 is configured to include a wavelength tunable interference filter 5, a detector 11, an I-V converter 12, an amplifier 13, an A/D converter 14, and a voltage controller 15.

The detector 11 receives light transmitted through the wavelength tunable interference filter 5 of the optical module 10 and outputs a detection signal (current) corresponding to the optical strength of the received light.

The I-V converter 12 converts the detection signal input from the detector 11 into a voltage value, and outputs it to the amplifier 13.

The amplifier 13 amplifies the voltage (detection voltage) corresponding to the detection signal input from the I-V converter 12.

The A/D converter 14 converts the detection voltage (analog signal) input from the amplifier 13 into a digital signal, and outputs it to the control unit 20.

The voltage controller 15 applies a voltage to an electrostatic actuator 56, which will be described later, of the wavelength tunable interference filter 5 to cause light with a desired wavelength corresponding to the applied voltage to be transmitted through the wavelength tunable interference filter 5.

### Configuration of a Wavelength Tunable Interference Filter

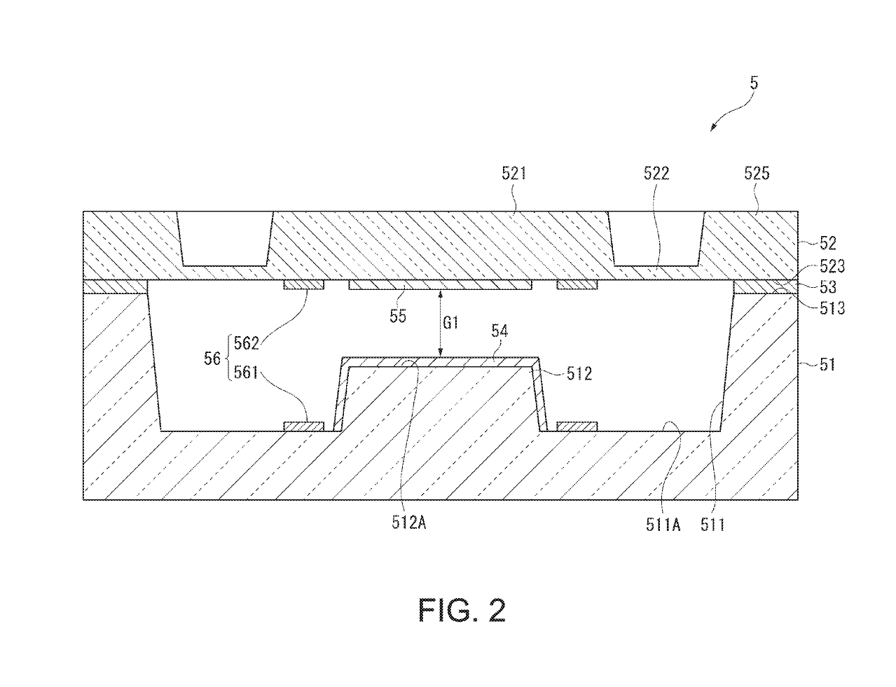

FIG. 2 is a cross-sectional view showing the schematic configuration of the wavelength tunable interference filter 5.

The wavelength tunable interference filter 5 of the present embodiment is a so-called Fabry-Perot etalon. As shown in FIG. 2, the wavelength tunable interference filter 5 includes a fixed substrate 51 and a movable substrate 52. The fixed substrate 51 and the movable substrate 52 are formed of, for example, various kinds of glass, quartz, and silicon. In addition, the fixed substrate 51 and the movable substrate 52 are integrally formed by bonding a first bonding portion 513 of the fixed substrate 51 and a second bonding portion 523 of the movable substrate 52 to each other using a bonding film 53 formed of a plasma-polymerized film containing siloxane as a main component, for example.

A fixed reflective film 54 (first reflective film) is provided on the fixed substrate 51, and a movable reflective film 55 (second reflective film) is provided on the movable substrate 52. The fixed reflective film 54 and the movable reflective film 55 are disposed so as to face each other with an inter-reflective film gap G1 (gap) interposed therebetween. In addition, the electrostatic actuator 56 used to adjust (change) the gap amount of the inter-reflective film gap G1 is provided in the wavelength tunable interference filter 5. The electrostatic actuator 56 is formed by a fixed electrode 561 (first electrode) provided on the fixed substrate 51 and a movable electrode 562 (second electrode) provided on the movable substrate 52. The fixed electrode 561 and the movable electrode 562 face each other with an inter-electrode gap interposed therebetween, and function as the electrostatic actuator 56. Here, the fixed electrode 561 and the movable electrode 562 may be directly provided on the surfaces of the fixed substrate 51 and the movable substrate 52, or may be provided with another film member interposed therebetween. In addition, although the example where the gap amount of the inter-electrode gap is larger than the gap amount of the inter-reflective film gap G1 is shown in FIG. 2, for example, the inter-electrode gap may be the same as or smaller than the inter-reflective film gap G1.

### Configuration of a Fixed Substrate

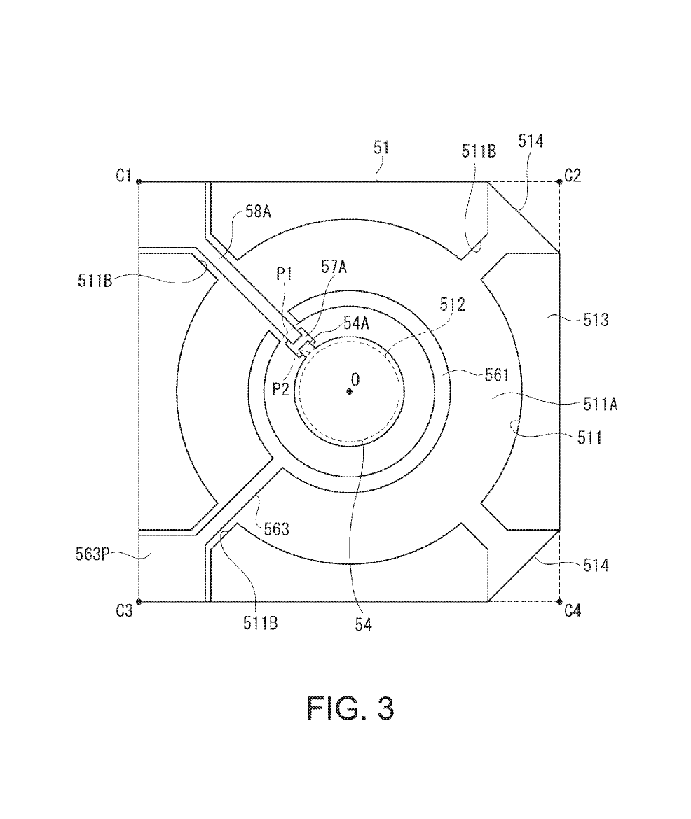

FIG. 3 is a plan view when the fixed substrate 51 is viewed from the movable substrate 52 side.

Since the fixed substrate 51 is thicker than the movable substrate 52, there is no bending of the fixed substrate due to electrostatic attraction by the electrostatic actuator 56 or the internal stress of a film member (for example, the fixed reflective film 54) formed on the fixed substrate 51.

As shown in FIG. 3, the fixed substrate 51 includes an electrode arrangement groove 511 and a reflective film arrangement portion 512 formed by etching, for example. In addition, since a cutout portion 514 is provided in a part of the outer peripheral edge (apices C2 and C4) of the fixed substrate 51, a movable extraction electrode 564 or a second wiring electrode 58B, which will be described later, is exposed to the surface of the wavelength tunable interference filter 5 through the cutout portion 514.

The electrode arrangement groove 511 is formed in a circular shape, which has a filter center point O of the fixed substrate 51 as its center, in plan view of the filter. The reflective film arrangement portion 512 is formed so as to protrude from the center of the electrode arrangement groove 511 to the movable substrate 52 side in plan view of the filter.

The groove bottom surface of the electrode arrangement groove 511 becomes an electrode arrangement surface 511A on which the fixed electrode 561 of the electrostatic actuator 56 is disposed. In addition, the protruding distal surface of the reflective film arrangement portion 512 becomes a reflective film arrangement surface 512A on which the fixed reflective film 54 is disposed.

In addition, an electrode extraction groove 511B extending from the electrode arrangement groove 511 toward each apex C1, C2, C3, and C4 of the outer peripheral edge of the fixed substrate 51 is provided in the fixed substrate 51.

A fixed electrode 561 provided along the virtual circle, which has the filter center point O as its center, is provided on the electrode arrangement surface 511A of the electrode arrangement groove 511. Specifically, the fixed electrode 561 is formed in an approximate C shape, in which a portion facing the apex C1 is open, in plan view of the filter.

In addition, a fixed extraction electrode 563 extending from the outer peripheral edge of the fixed electrode 561 to the apex C3 along the electrode extraction groove 511B toward the apex C3 is provided in the fixed substrate 51. An extending distal portion (portion located at the apex C3 of the fixed substrate 51) of the fixed extraction electrode 563 forms a fixed electrode pad 563P connected to the voltage controller 15.

The fixed electrode 561 may be formed of any kind of material as long as it has conductivity. In the present embodiment, the fixed electrode 561 is formed of the same material as a first conductive member 57A to be described later. Specifically, the fixed electrode 561 is formed of metal oxide having good adhesion to a metal film or an alloy film. More specifically, the fixed electrode 561 is formed of an indium tin oxide (ITO) film.

In addition, an insulating film for ensuring the insulation between the fixed electrode 561 and the movable electrode 562 may be laminated on the fixed electrode 561.

In addition, although the configuration in which one fixed electrode 561 is provided on the electrode arrangement surface 511A is shown in the present embodiment, for example, it is possible to adopt a configuration (double electrode configuration) in which two electrodes as concentric circles having the filter center point O as their center are provided.

In addition, in the electrode arrangement groove 511, the first conductive member 57A is provided between the fixed electrode 561 and the fixed reflective film 54. Specifically, the first conductive member 57A is provided at a position corresponding to the C-shaped opening portion of the fixed electrode 561 between a virtual circle P1 along the C-shaped inner periphery of the fixed electrode 561 and an outer circumference P2 of the fixed reflective film 54. The first conductive member 57A is formed of the same material as the fixed electrode 561. In the present embodiment, the first conductive member 57A is formed of an ITO film.

In addition, a first wiring electrode 58A that is connected to the first conductive member 57A and extends toward the apex C1 is provided in the electrode arrangement groove 511.

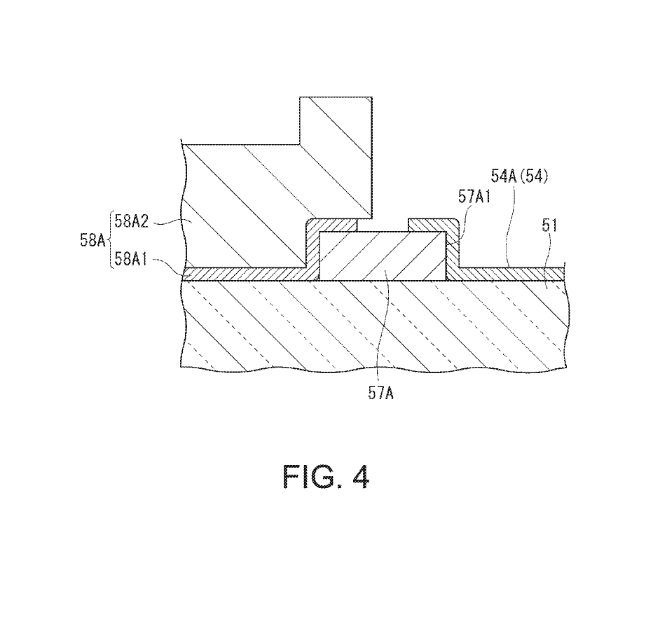

FIG. 4 is a cross-sectional view schematically showing a connection state of the first wiring electrode 58A and the fixed reflective film 54 through the first conductive member 57A.

As shown in FIGS. 3 and 4, the first wiring electrode 58A is formed so as to extend from the upper surface of the first conductive member 57A to the apex C1 of the fixed substrate 51. That is, the first wiring electrode 58A is provided so as to cover an end 57A1 on the outer side (apex C1 side) of the first conductive member 57A. Accordingly, since the first wiring electrode 58A is in close contact with the first conductive member 57A, the first wiring electrode 58A is electrically connected to the first conductive member 57A.

In addition, in the present embodiment, as shown in FIG. 4, the first wiring electrode 58A is formed by abase layer 58A1 and an electrode layer 58A2. Cr is used as a material of the base layer 58A1, and Au is used as a material of the electrode layer 58A2. When using Au as a material of the electrode layer 58A2, terminal connectivity when connecting the wavelength tunable interference filter 5 to the voltage controller 15 is good, and conductivity is also good. Accordingly, it is possible to suppress an increase in electrical resistance. In addition, it is possible to prevent the peeling of the first wiring electrode 58A by using Cr with high adhesion with Au and high adhesion with a glass substrate (fixed substrate 51) as the base layer 58A1. In addition, as described above, since the first conductive member 57A is formed of an ITO film that is a metal oxide, adhesion of the first conductive member 57A to a metal film is good. Accordingly, the first conductive member 57A also adheres satisfactorily to Cr of the base layer 58A1. In the present embodiment, therefore, since it is possible to ensure sufficient adhesion between the first wiring electrode 58A and the first conductive member 57A, it is possible to prevent disconnection due to peeling and the like.

In addition, in the present embodiment, an electrode having a two-layer structure in which the base layer 58A1 is formed of Cr and the electrode layer 58A2 is formed of Au has been exemplified as the first wiring electrode 58A. However, it is also possible to use other metal films, which adhere to the glass substrate or the first conductive member 57A and have conductivity, as single layers.

As described above, the reflective film arrangement portion 512 is formed in an approximately cylindrical shape, which has a smaller diameter than the electrode arrangement groove 511, on the same axis as the electrode arrangement groove 511, and includes the reflective film arrangement surface 512A facing the movable substrate 52 of the reflective film arrangement portion 512.

As shown in FIGS. 2 and 3, the fixed reflective film 54 is provided in the reflective film arrangement portion 512. As the fixed reflective film 54, for example, it is preferable to use a metal film, such as Ag, and an alloy film, such as an Ag alloy. In addition, it is also possible to use a dielectric multilayer film having a high refractive layer of TiO₂ and a low refraction layer of SiO₂, for example. In addition, it is also possible to use a reflective film in which a metal film (or an alloy film) is laminated on a dielectric multilayer film, a reflective film in which a dielectric multilayer film is laminated on a metal film (or an alloy film), a reflective film in which a single refractive layer (for example, TiO₂ or SiO₂) and a metal film (or an alloy film) are laminated, and the like. In the present embodiment, a configuration in which the fixed reflective film 54 is an Ag alloy film is illustrated.

In addition, the fixed reflective film 54 includes a fixed extraction portion 54A that extends slightly toward the apex C1. The fixed extraction portion 54A is connected to the first conductive member 57A disposed between the fixed electrode 561 and the fixed reflective film 54. Specifically, the fixed extraction portion 54A of the fixed reflective film 54 is provided so as to cover the end 57A1 on the inner side (filter center point O side) of the first conductive member 57A. Accordingly, since the fixed extraction portion 54A is inclose contact with the first conductive member 57A, the fixed extraction portion 54A is electrically connected to the first conductive member 57A. Therefore, the fixed reflective film 54 is electrically connected to the first wiring electrode 58A through the first conductive member 57A.

In addition, when using a dielectric multilayer film as the fixed reflective film 54, the fixed extraction portion 54A is formed, for example, by providing a conductive film on an uppermost layer (layer closest to the movable substrate 52) of the dielectric multilayer film or a lowest layer (layer closest to the fixed substrate 51) of the dielectric multilayer film and extending a part of the conductive film toward the apex C1. As the conductive film, for example, an ITO film, a metal film, and a metal alloy film can be used.

Here, the thickness of the fixed reflective film 54 (fixed extraction portion 54A), the first conductive member 57A, and the first wiring electrode 58A in the present embodiment will be described.

The first wiring electrode 58A is formed in a relatively large thickness in order to reduce the electrical resistance. In the present embodiment, the first wiring electrode 58A is formed in a thickness of about 200 nm, for example.

On the other hand, the fixed reflective film 54 (fixed extraction portion 54A) is formed in a small thickness from the need to balance both the transmission and reflection characteristics in the fixed reflective film 54. Specifically, the fixed reflective film 54 (fixed extraction portion 54A) is formed in a thickness of 15 nm to 80 nm. More preferably, the thickness of the fixed reflective film 54 (fixed extraction portion 54A) is 15 nm to 40 nm. In the present embodiment, the fixed reflective film 54 (fixed extraction portion 54A) is formed in a thickness of about 30 nm, for example. When the thickness of the fixed reflective film 54 is less than 15 nm, the reflection characteristic is lowered and the amount of transmitted light is increased. Accordingly, the characteristics of the wavelength tunable interference filter 5 are lowered. In addition, when the thickness of the fixed reflective film 54 is larger than 80 nm, the amount of transmitted light is reduced. Accordingly, it is not possible to obtain a sufficient amount of received light. In contrast, it is possible to obtain the transmission and reflection characteristics of appropriate values by setting the thickness of the fixed reflective film 54 within the above-described range.

The first conductive member 57A is thinner than the first wiring electrode 58A.

Thus, since the thickness of the first conductive member 57A is smaller than that of the first wiring electrode 58A, a step height from the upper surface of the first conductive member 57A to the surface of the fixed substrate 51 is lower than a step height from the upper surface of the first wiring electrode 58A to the surface of the fixed substrate 51. Therefore, in the configuration in which the fixed extraction portion 54A covers the end 57A1 of the first conductive member 57A, it is possible to reduce the risk of disconnection of the fixed extraction portion 54A in a stepped portion, compared with a configuration in which the fixed extraction portion 54A covers the end of the first wiring electrode 58A.

Specifically, it is preferable to form the first conductive member 57A in a thickness of 15 nm to 150 nm. More preferably, the thickness of the first conductive member 57A is 15 nm to 80 nm. In the present embodiment, the first conductive member 57A is formed in a thickness of about 60 nm, for example. When the thickness of the first conductive member 57A is larger than 150 nm, the risk of disconnection of the fixed extraction portion 54A in a stepped portion is increased. In addition, the thickness of the first conductive member 57A may be equal to or less than 15 nm. In this case, however, the electrical resistance of the first conductive member 57A may be increased.

On the light incidence surface (surface on which the fixed reflective film 54 is not provided) of the fixed substrate 51, an antireflection film may be formed at a position corresponding to the fixed reflective film 54. The antireflection film can be formed by laminating a low refractive index film and a high refractive index film alternately, and reduces the reflectance of visible light at the surface of the fixed substrate 51. As a result, the transmittance is increased.

In addition, a portion of the surface of the fixed substrate 51 facing the movable substrate 52, on which the electrode arrangement groove 511, the reflective film arrangement portion 512, and the extraction electrode arrangement groove are not formed, forms the first bonding portion 513. The first bonding portion 513 is bonded to the second bonding portion 523 of the movable substrate 52 through the bonding film 53.

### Configuration of a Movable Substrate

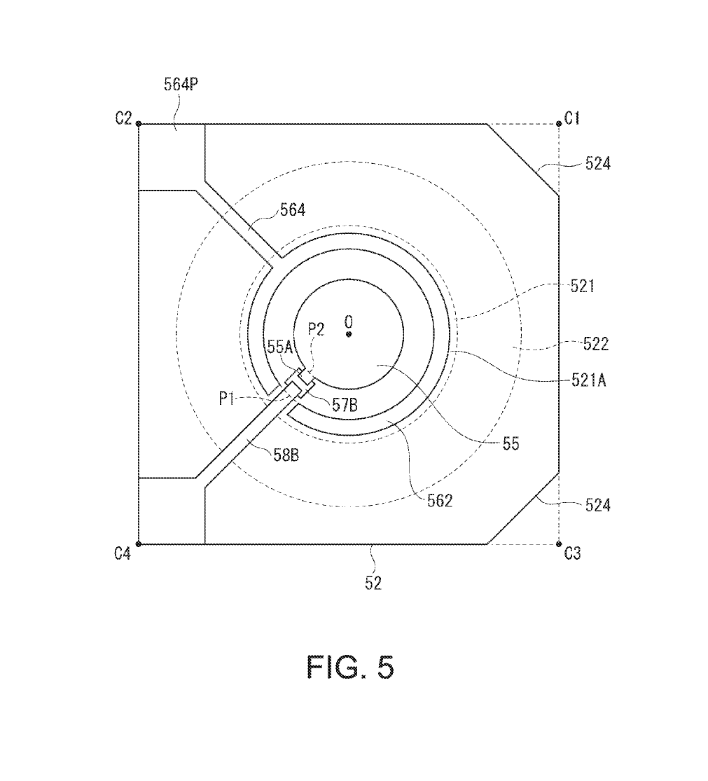

FIG. 5 is a plan view when the movable substrate 52 is viewed from the fixed substrate 51 side. In addition, each apex C1, C2, C3, and C4 of the movable substrate 52 in FIG. 5 corresponds to each apex C1, C2, C3, and C4 of the fixed substrate 51 shown in FIG. 3.

As shown in FIGS. 2 and 5, in plan view of the filter, the movable substrate 52 includes a movable portion 521 having a circular shape with the filter center point O as its center, a holding portion 522 that is coaxial with the movable portion 521 and holds the movable portion 521, and a substrate outer peripheral portion 525 provided outside the holding portion 522.

In addition, as shown in FIG. 5, a cutout portion 524 is provided at the apices C1 and C3 on the movable substrate 52. Through the cutout portion 524, a distal end of the first wiring electrode 58A or the fixed extraction electrode 563 is exposed as described above.

The movable portion 521 is thicker than the holding portion 522. In the present embodiment, for example, the movable portion 521 has the same thickness as the movable substrate 52 (substrate outer peripheral portion 525). The movable portion 521 is formed so as to have a larger diameter than at least the diameter of the outer peripheral edge of the reflective film arrangement surface 512A in plan view of the filter. In addition, the movable reflective film 55 and the movable electrode 562 are provided on a movable surface 521A of the movable portion 521 facing the fixed substrate 51.

In addition, similar to the fixed substrate 51, an antireflection film may be formed on a surface of the movable portion 521 not facing the fixed substrate 51.

As shown in FIG. 5, in plan view of the filter, the movable electrode 562 is provided in a region facing the fixed electrode 561 outside the movable reflective film 55, and is formed in an approximate C shape in which a portion facing the apex C4 is open.

In addition, the movable extraction electrode 564, which extends in a direction of the apex C2 and is disposed opposite the electrode extraction groove 511B toward the apex C2 of the fixed substrate 51, is provided in the movable electrode 562. An extending distal portion (portion located at the apex C2 of the movable substrate 52) of the movable extraction electrode 564 forms a movable electrode pad 564P connected to the voltage controller 15.

In the electrode configuration described above, as shown in FIG. 2, the electrostatic actuator 56 is formed by an arc region where the fixed electrode 561 and the movable electrode 562 overlap each other.

In addition, in the present embodiment, as shown in FIG. 2, the gap between the fixed electrode 561 and the movable electrode 562 is formed so as to be larger than the inter-reflective film gap G1. However, the gap between the fixed electrode 561 and the movable electrode 562 is not limited thereto. For example, when infrared light or far-infrared light is set as measurement target light, the inter-reflective film gap G1 may be configured to be larger than the gap between the electrodes 561 and 562 depending on the wavelength range of the measurement target light.

In addition, in the movable portion 521, a second conductive member 57B is provided between the movable electrode 562 and the movable reflective film 55. Specifically, the second conductive member 57B is provided at a position corresponding to the C-shaped opening portion of the movable electrode 562 between a virtual circle P1 along the C-shaped inner periphery of the movable electrode 562 and an outer circumference P2 of the movable reflective film 55. The second conductive member 57B is formed of the same material as the movable electrode 562. In the present embodiment, the second conductive member 57B is formed of an ITO film.

Thus, since the second conductive member 57B is provided in the movable portion 521, it is possible to prevent the bending of the holding portion 522 due to the internal stress of the second conductive member 57B and the like.

In addition, the second wiring electrode 58B that is connected to the second conductive member 57B and extends toward the apex C4 of the movable substrate 52 from the movable portion 521 is provided in the movable substrate 52.

In addition, since the configuration for connection between the second wiring electrode 58B and the second conductive member 57B is the same as the configuration for connection between the first wiring electrode 58A and the first conductive member 57A shown in FIG. 4, explanation thereof will be omitted herein. That is, the second wiring electrode 58B is provided so as to cover the end of the movable substrate 52 on the apex C4 side on the upper surface of the second conductive member 57B. Accordingly, since the second wiring electrode 58B is in close contact with the second conductive member 57B, the second wiring electrode 58B is electrically connected to the second conductive member 57B.

In addition, similar to the first wiring electrode 58A, the second wiring electrode 58B is formed of Cr, which is a material of a base layer, and Au, which is a material of an electrode layer. In this case, terminal connectivity when connecting the second wiring electrode 58B to the voltage controller 15 is good, and conductivity is also good. Accordingly, it is possible to suppress an increase in electrical resistance. In addition, by using Cr as a material of the base layer, it is possible to sufficiently ensure adhesion between the base layer and the electrode layer, adhesion between the base layer and a glass substrate (movable substrate 52), and adhesion between the base layer and the second conductive member 57B (ITO film). As a result, it is possible to prevent disconnection due to peeling and the like.

The movable reflective film 55 is formed of the same material as the fixed reflective film 54. Accordingly, in the present embodiment, an Ag alloy film is used as the movable reflective film 55.

In addition, similar to the fixed reflective film 54, the movable reflective film 55 includes a movable extraction portion 55A that extends slightly toward the apex C4. Similar to the fixed extraction portion 54A shown in FIGS. 3 and 4, the movable extraction portion 55A is bonded to the second conductive member 57B, so that the movable extraction portion 55A is electrically connected to the second wiring electrode 58B through the second conductive member 57B.

The holding portion 522 is a diaphragm surrounding the periphery of the movable portion 521, and is thinner than the movable portion 521. Such a holding portion 522 bends more easily than the movable portion 521 does. Accordingly, it is possible to displace the movable portion 521 to the fixed substrate 51 side by slight electrostatic attraction. In this case, since the movable portion 521 has larger thickness and rigidity than the holding portion 522, a change in the shape of the movable portion 521 is suppressed even if the holding portion 522 is pulled to the fixed substrate 51 side due to electrostatic attraction. Accordingly, since the bending of the movable reflective film 55 provided in the movable portion 521 is also suppressed, it is possible to maintain the fixed reflective film 54 and the movable reflective film 55 in a parallel state.

In addition, although the diaphragm-like holding portion 522 is illustrated in the present embodiment, the invention is not limited thereto. For example, beam-shaped holding portions, which are disposed at equal angular intervals around the filter center point O, may also be provided.

As described above, the substrate outer peripheral portion 525 is provided outside the holding portion 522 in plan view of the filter. The second bonding portion 523 facing the first bonding portion 513 is provided on a surface of the substrate outer peripheral portion 525 facing the fixed substrate 51, and is bonded to the first bonding portion 513 through the bonding film 53.

### Configuration of a Voltage Controller

The voltage controller 15 is connected to the fixed extraction electrode 563 (fixed electrode pad 563P), the movable extraction electrode 564 (movable electrode pad 564P), the first wiring electrode 58A, and the second wiring electrode 58B of the wavelength tunable interference filter 5.

In addition, when a voltage command signal corresponding to the measurement target wavelength is received from the control unit 20, the voltage controller 15 applies a corresponding voltage between the fixed extraction electrode 563 and the movable extraction electrode 564. Then, an electrostatic attraction based on the applied voltage is generated in the electrostatic actuator 56 (between the fixed electrode 561 and the movable electrode 562) of the wavelength tunable interference filter 5. As a result, the movable portion 521 is displaced to the fixed substrate 51 side, and the gap amount of the inter-reflective film gap G1 is changed.

In addition, the voltage controller 15 is connected to the first and second wiring electrodes 58A and 58B, and the wiring electrodes 58A and 58B are connected to GND. Accordingly, even if electric charges are collected on the fixed reflective film 54 and the movable reflective film 55, it is possible to prevent the charging of the fixed reflective film 54 and the movable reflective film 55 by moving the electric charges to GND.

In addition, although the example where the fixed reflective film 54 and the movable reflective film 55 are made to function as antistatic electrodes is shown in the present embodiment, the invention is not limited thereto. For example, the fixed reflective film 54 and the movable reflective film 55 may be made to function as electrodes for capacitance measurement. In this case, the voltage controller 15 applies a high-frequency voltage to the extent not affecting the driving between the first and second wiring electrodes 58A and 58B, and measures the capacitance of the fixed reflective film 54 and the movable reflective film 55. In such a configuration, the gap amount of the inter-reflective film gap G1 can be calculated on the basis of the measured capacitance. Accordingly, when the measured gap amount is different from the gap amount corresponding to the measurement target wavelength, the voltage controller 15 can correct the gap amount to an appropriate value by applying a feedback voltage between the fixed extraction electrode 563 and the movable extraction electrode 564.

In addition, the fixed reflective film 54 and the movable reflective film 55 may be made to function as driving electrodes. In this case, the voltage controller 15 can perform more accurate gap control of the inter-reflective film gap G1 by making different of a voltage applied between the fixed extraction electrode 563 and the movable extraction electrode 564 and a voltage applied between the first and second wiring electrodes 58A and 58B. For example, it is possible to displace the movable portion 521 by a predetermined amount by applying a predetermined bias voltage between the first and second wiring electrodes 58A and 58B and then apply a feedback voltage between the first and second wiring electrodes 58A and 58B.

### Configuration of a Control Unit

The control unit 20 is configured to include a CPU, a memory, and the like, for example, and performs overall control of the spectrometer 1. As shown in FIG. 1, the control unit 20 includes a wavelength setting section 21, a light amount acquisition section 22, and a spectroscopic measurement section 23.

In addition, the control unit 20 includes a storage section 30 that stores various kinds of data, and V-λ data for controlling the electrostatic actuator 56 is stored in the storage section 30. A peak wavelength of light, which is transmitted through the wavelength tunable interference filter 5, with respect to the voltage applied to the electrostatic actuator 56 is recorded in the V-λ data.

The wavelength setting section 21 sets a desired wavelength of light extracted by the wavelength tunable interference filter 5, and reads a target voltage value corresponding to the desired wavelength set from the V-λ data stored in the storage section 30. In addition, the wavelength setting section 21 outputs to the voltage controller 15 a control signal to apply the read target voltage value. As a result, a voltage of the target voltage value is applied from the voltage controller 15 to the electrostatic actuator 56.

The light amount acquisition section 22 acquires the amount of light with a desired wavelength, which has been transmitted through the wavelength tunable interference filter 5, on the basis of the amount of light acquired by the detector 11.

The spectroscopic measurement section 23 measures the spectral characteristics of the measurement target light on the basis of the amount of light acquired by the light amount acquisition section 22.

As examples of the spectroscopy method in the spectroscopic measurement section 23, a method of measuring the spectrum with the amount of light detected for the measurement target wavelength by the detector 11 as the amount of light of the measurement target wavelength and a method of estimating the spectrum on the basis of the amount of light of a plurality of measurement target wavelengths can be mentioned.

As a method of estimating the spectrum, for example, the spectrum of light to be measured is estimated by generating a measurement spectrum matrix, which has each amount of light for a plurality of measurement target wavelengths as a matrix element, and applying a predetermined transformation matrix to the measurement spectrum matrix. In this case, a plurality of sample light beams whose spectrum is known are measured by the spectrometer 1, and a transformation matrix is set such that a deviation between a matrix, which is obtained by applying the transformation matrix to a measurement spectrum matrix generated on the basis of the amount of light obtained by measurement, and the known spectrum becomes minimum.

### Method of Manufacturing a Wavelength Tunable Interference Filter

Next, a method of manufacturing the wavelength tunable interference filter 5 described above will be described with reference to the accompanying drawings.

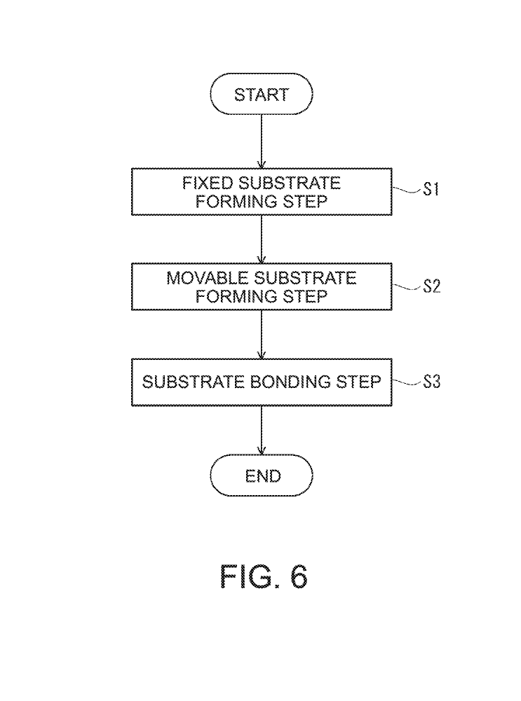

FIG. 6 is a flowchart showing the manufacturing process of the wavelength tunable interference filter 5.

In the manufacture of the wavelength tunable interference filter 5, first, a first glass substrate M1 for forming the fixed substrate 51 and a second glass substrate M2 for forming the movable substrate 52 are prepared, and a fixed substrate forming step S1 and a movable substrate forming step S2 are performed. Then, a substrate bonding step S3 is performed to bond the first glass substrate M1 processed in the fixed substrate forming step S1 to the second glass substrate M2 processed in the movable substrate forming step S2, and the wavelength tunable interference filter 5 is cut in units of a chip.

Hereinafter, each of the steps S1 to S3 will be described with reference to the accompanying drawings.

### Fixed Substrate Forming Step

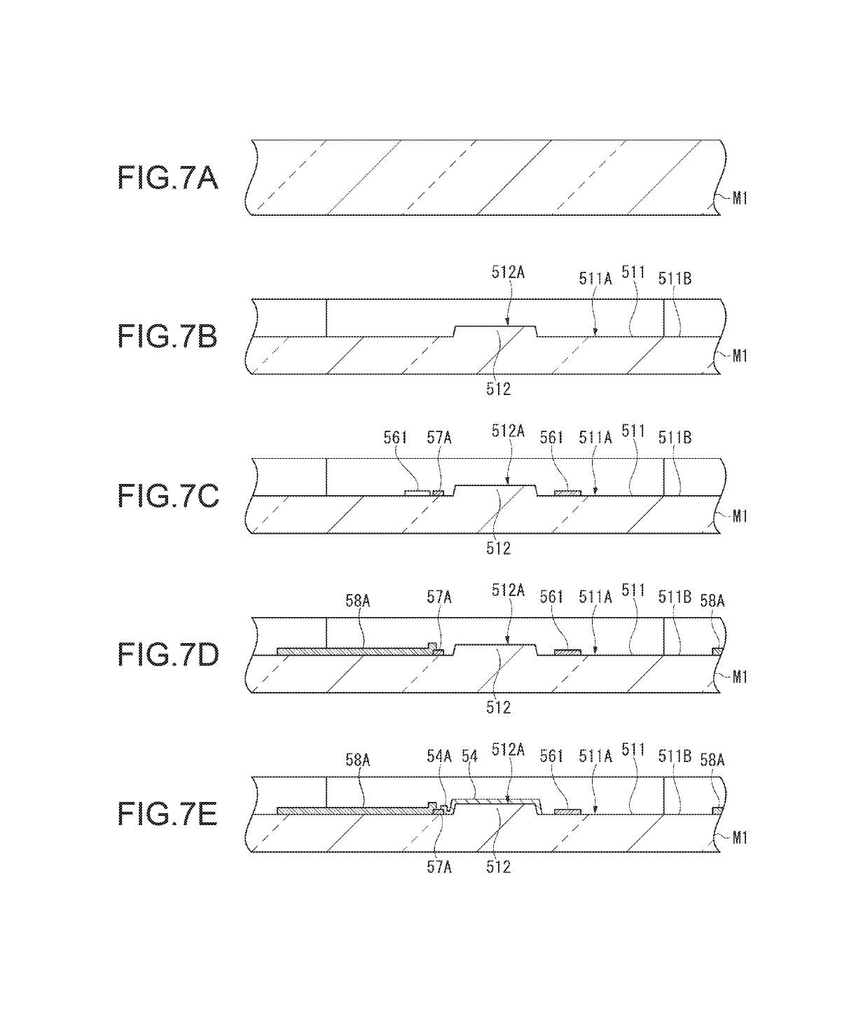

FIGS. 7A to 7E are diagrams showing the state of the first glass substrate M1 in the fixed substrate forming step S1.

In the fixed substrate forming step S1, as shown in FIG. 7A, first, both surfaces of the first glass substrate M1 that is a manufacturing material of the fixed substrate 51 are finely polished until the surface roughness Ra becomes equal to or less than 1 nm.

Then, as shown in FIG. 7B, the surface of the first glass substrate M1 is processed by etching.

Specifically, a resist is applied onto the surface of the first glass substrate M1 and the applied resist is exposed and developed using a photolithography method, thereby performing patterning such that a portion where the reflective film arrangement surface 512A is formed is open. Here, in the present embodiment, a plurality of fixed substrates 51 are formed from the single first glass substrate M1. Accordingly, in this step, a resist pattern is formed on the first glass substrate M1 so that a plurality of fixed substrates 51 are manufactured in a state where the fixed substrates 51 are arranged in parallel in an array.

Then, wet etching using, for example, hydrofluoric acid is performed on both the surfaces of the first glass substrate M1. In this case, the etching is performed up to the depth of the reflective film arrangement surface 512A. Then, a resist is formed so that a portion where the electrode arrangement groove 511 and the extraction electrode arrangement groove are formed is open, and wet etching is further performed.

As a result, as shown in FIG. 7B, the first glass substrate M1 in which the substrate shape of the fixed substrate 51 is determined is formed.

Then, an electrode material for forming the fixed electrode 561, the fixed extraction electrode 563, and the first conductive member 57A is formed on the fixed substrate 51 in a thickness of 100 nm using a vapor deposition method or a sputtering method, for example. Then, as shown in FIG. 7C, the fixed electrode 561, the fixed extraction electrode 563, and the first conductive member 57A are formed by performing patterning using a photolithography method. In addition, the fixed extraction electrode 563 is not shown in FIGS. 7A to 7E.

Then, an electrode material for forming the first wiring electrode 58A is formed on the fixed substrate 51 in a thickness of 200 nm using a vapor deposition method or a sputtering method, for example. In the present embodiment, Au that is a material of the electrode layer 58A2 is formed after forming Cr that is a material of the base layer 58A1. Then, patterning is performed using a photolithography method. As a result, as shown in FIG. 7D, the first wiring electrode 58A is formed.

In addition, when forming an insulating layer on the fixed electrode 561, for example, SiO₂ with a thickness of about 100 nm is formed on the entire surface of the fixed substrate 51 facing the movable substrate 52 using plasma CVD or the like after forming the fixed electrode 561. In addition, SiO₂ on the fixed electrode pad 563P is removed by dry etching, for example.

Then, as shown in FIG. 7E, the fixed reflective film 54 is formed on the reflective film arrangement surface 512A. Here, in the present embodiment, an Ag alloy film is used as the fixed reflective film 54. When using a metal film, such as an Ag alloy, or an alloy film, such as an Ag alloy, as the fixed reflective film 54, a film layer for the fixed reflective film 54 is formed on the surface of the fixed substrate 51, on which the electrode arrangement groove 511 or the reflective film arrangement portion 512 is formed, using a vapor deposition method or a sputtering method. The thickness of the fixed reflective film 54 may be appropriately determined according to the optical characteristics of the wavelength tunable interference filter 5. For example, in order to maintain both the transmission and reflection characteristics, the fixed reflective film 54 is formed in a thickness of about 30 nm. Then, the fixed reflective film 54 is patterned using a photolithography method. In this case, the patterning is performed such that the fixed extraction portion 54A of the fixed reflective film 54 is connected to the end 57A1 of the first conductive member 57A.

Here, since the thickness of the first conductive member 57A is smaller than that of the first wiring electrode 58A, adhesion of the fixed reflective film 54 to the first conductive member 57A is good. That is, when forming the fixed reflective film 54 on the first wiring electrode 58A, the fixed reflective film 54 may not be formed on the end surface of the first wiring electrode 58A since the thickness of the fixed reflective film 54 with respect to the first wiring electrode 58A is small. In contrast, when the first conductive member 57A that is thinner than the first wiring electrode 58A is covered with the fixed reflective film 54 as in the present embodiment, it is possible to reduce the risk of the fixed reflective film 54 not being formed on the end surface of the first conductive member 57A, compared with a case where the first wiring electrode 58A is covered with the fixed reflective film 54.

In addition, when a dielectric multilayer film is formed as the fixed reflective film 54, the dielectric multilayer film can be formed by a lift-off process, for example. In this case, a resist (lift-off pattern) is formed in a portion of the fixed substrate 51 other than the portion, in which the reflective film is formed, using a photolithography method or the like. Then, a material (for example, a dielectric multilayer film having a high refraction layer formed of TiO₂ and a low refraction layer of SiO₂) for forming the fixed reflective film 54 is formed using a sputtering method or a vapor deposition method. Then, unnecessary portions of the film are removed by lift-off. Then, a conductive film, such as an ITO film, is formed on the surface of the fixed substrate 51, on which the electrode arrangement groove 511 or the reflective film arrangement portion 512 is formed, in a thickness of, for example, about 30 nm, and is patterned using a photolithography method. In this case, in the same manner as in the case where the Ag alloy film is used, the patterning is performed such that the fixed extraction portion 54A of the fixed reflective film 54 is connected to the end 57A1 of the first conductive member 57A.

In this manner, the first glass substrate M1 on which a plurality of fixed substrates 51 are disposed in an array is manufactured.

### Movable Substrate Forming Step

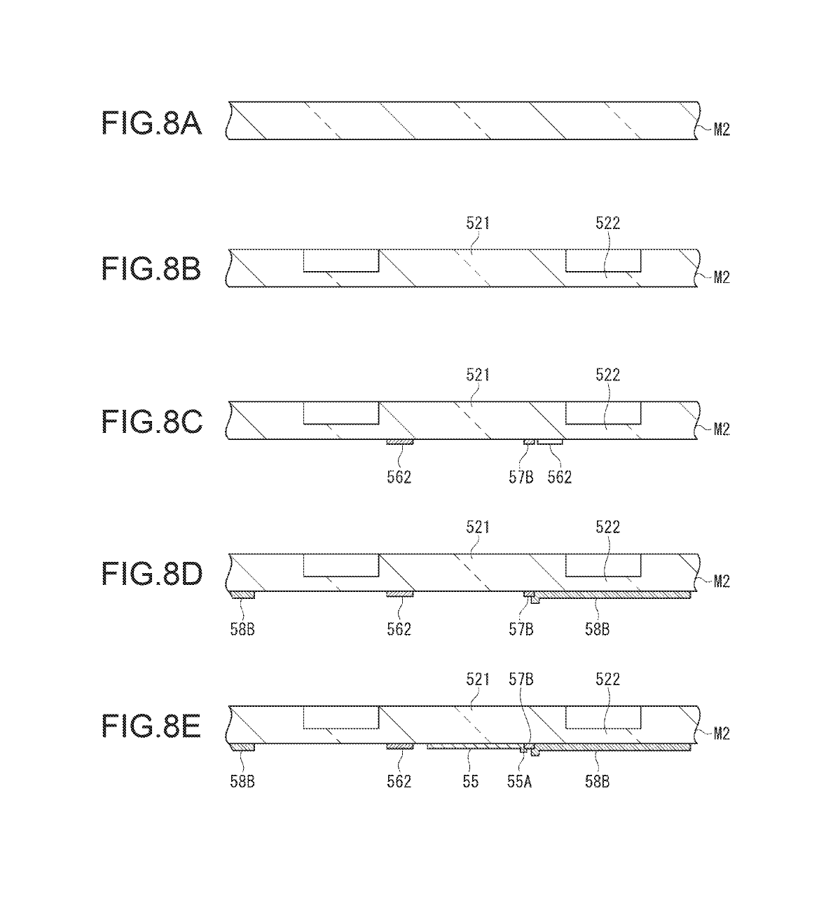

Next, the movable substrate forming step S2 will be described. FIGS. 8A to 8E are diagrams showing the state of the second glass substrate M2 in the movable substrate forming step S2.

In the movable substrate forming step S2, as shown in FIG. 8A, first, both surfaces of the second glass substrate M2 are finely polished until the surface roughness Ra becomes equal to or less than 1 nm. Then, a resist is applied onto the entire surface of the second glass substrate M2 and the applied resist is exposed and developed using a photolithography method, thereby patterning a portion where the holding portion 522 is formed.

Then, as shown in FIG. 8B, the movable portion 521, the holding portion 522, and the substrate outer peripheral portion 525 are formed by performing wet etching of the second glass substrate M2. In this manner, the second glass substrate M2 in which the substrate shape of the movable substrate 52 is determined is manufactured.

Then, as shown in FIG. 8C, the movable electrode 562, the movable extraction electrode 564, and the second conductive member 57B are formed. When forming the movable electrode 562, the movable extraction electrode 564, and the second conductive member 57B, an electrode material is formed on the movable substrate 52 in a thickness of, for example, 100 nm using a vapor deposition method, a sputtering method, or the like and is patterned using a photolithography method, in the same manner as when forming the fixed electrode 561 on the fixed substrate 51. In addition, the movable extraction electrode 564 is not shown in FIGS. 8A to 8E.

Then, an electrode material for forming the second wiring electrode 58B on the movable substrate 52 is formed. Formation of the second wiring electrode 58B is similar to the formation of the first wiring electrode 58A. For example, the second wiring electrode 58B is formed in a thickness of 200 nm using a vapor deposition or a sputtering method. Then, patterning is performed using a photolithography method. As a result, as shown in FIG. 8D, the second wiring electrode 58B is formed.

Then, as shown in FIG. 8E, the movable reflective film 55 is formed on the movable surface 521A. The movable reflective film 55 can be formed using the same method as for the fixed reflective film 54. That is, when using a metal film, such as Ag, or an alloy film, such as an Ag alloy, as the movable reflective film 55, a film layer for the movable reflective film 55 is formed on the movable substrate 52 in a thickness of about 30 nm using, for example, a vapor deposition method or a sputtering method and then is patterned using a photolithography method. In this case, the patterning is performed such that the movable extraction portion 55A is connected to the end of the second conductive member 57B.

In addition, when forming a dielectric multilayer film as the movable reflective film 55, for example, the dielectric multilayer film is formed by lift-off process, and then unnecessary portions are removed by performing a lift-off. Then, a conductive film, such as an ITO film, is formed using a vapor deposition method, a sputtering method, or the like, and is patterned using a photolithography method or the like.

In this manner, the second glass substrate M2 on which a plurality of movable substrates 52 are disposed in an array is manufactured.

### Substrate Bonding Step

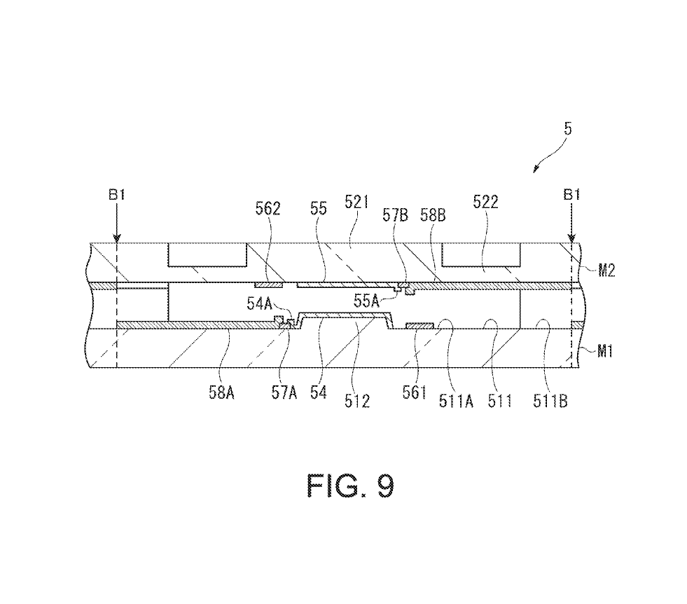

Next, a substrate bonding step S3 will be described. FIG. 9 is a diagram showing the state of the first and second glass substrates M1 and M2 in the substrate bonding step S3.

In the substrate bonding step S3, a plasma-polymerized film (bonding film 53) containing polyorganosiloxane as a main component is first formed on the first bonding portion 513 of the first glass substrate M1 and the second bonding portion 523 of the second glass substrate M2 using a plasma CVD method, for example. As the thickness of the bonding film 53, for example, 10 nm to 1000 nm is preferable.

In addition, in order to provide the activation energy to the plasma-polymerized film of each of the first and second glass substrates M1 and M2, O₂ plasma treatment or UV treatment is performed. O₂ plasma treatment is performed for 30 seconds under the conditions of O₂ flow rate of 1.8×10⁻³ (m³/h), pressure of 27 Pa, and RF power of 200 W. In addition, UV treatment is performed for 3 minutes using excimer UV (wavelength of 172 nm) as a UV light source.

After providing the activation energy to the plasma-polymerized film, the alignment of the first and second glass substrates M1 and M2 is performed so that the first and second glass substrates M1 and M2 overlap each other with their plasma-polymerized films interposed therebetween, and the load of 98 (N) is applied to the junction for 10 minutes, for example. As a result, the first and second glass substrates M1 and M2 are bonded to each other.

Then, a cutting step of extracting each wavelength tunable interference filter 5 in units of a chip is performed. Specifically, a bonding body of the first and second glass substrates M1 and M2 is cut along the line B1 shown in FIG. 9. For the cutting, for example, laser cutting can be used. As described above, the wavelength tunable interference filter 5 is manufactured in units of a chip.

### Operations and Effects of the First Embodiment

In the present embodiment, the wavelength tunable interference filter 5 includes the fixed substrate 51 on which the fixed reflective film 54 is provided and the movable substrate 52 on which the movable reflective film 55 is provided. In addition, the fixed extraction portion 54A of the fixed reflective film 54 is connected to the first wiring electrode 58A through the first conductive member 57A having a smaller thickness than the first wiring electrode 58A.

In such a configuration, the height of a stepped portion between the first conductive member 57A and the fixed substrate 51 is lower than the height of a stepped portion between the first wiring electrode 58A and the fixed substrate 51. Therefore, in the configuration in which the fixed extraction portion 54A and the first conductive member 57A are connected to each other by covering the first conductive member 57A with the fixed extraction portion 54A, the risk of disconnection of the fixed extraction portion 54A in the stepped portion is reduced, compared with a configuration in which the fixed extraction portion 54A and the first wiring electrode 58A are connected to each other by covering the first wiring electrode 58A with the fixed extraction portion 54A. In addition, also in the fixed substrate manufacturing step, when the fixed reflective film 54 is provided for the first wiring electrode 58A with a large thickness, the fixed reflective film 54 may not be formed on the end surface of the first wiring electrode 58A. As a result, the risk of disconnection becomes high. In contrast, when the fixed reflective film 54 is formed for the first conductive member 57A with a small thickness, the fixed reflective film 54 is easily formed on the end surface of the first conductive member 57A. As a result, the risk of disconnection can be reduced.

As described above, in the present embodiment, since the risk of disconnection can be reduced by connecting the fixed reflective film 54 and the first wiring electrode 58A to each other through the first conductive member 57A, it is possible to improve the connection reliability. As a result, it is also possible to improve the equipment reliability in the optical module 10 or the spectrometer 1.

Similarly, the movable reflective film 55 is also connected to the second wiring electrode 58B through the second conductive member 57B having a smaller thickness than the second wiring electrode 58B. Therefore, similar to the fixed reflective film 54 described above, since the risk of disconnection of the movable reflective film 55 and the second conductive member 57B can be reduced, it is possible to improve the connection reliability.

In the present embodiment, the first conductive member 57A is disposed between the virtual circle P1 along the inner periphery of the fixed electrode 561 and an outer circumference P2 of the fixed reflective film 54. Similarly, the second conductive member 57B is disposed between the virtual circle P1 along the inner periphery of the movable electrode 562 and the outer circumference P2 of the movable reflective film 55.

In such a configuration, since the extraction length of the fixed extraction portion 54A of the fixed reflective film 54 is reduced, it is possible to reduce the electrical resistance in the fixed extraction portion 54A. Similarly, also in the movable reflective film 55, since the extraction length of the movable extraction portion 55A is reduced, it is possible to reduce the electrical resistance in the movable extraction portion 55A.

Therefore, when the reflective films 54 and 55 also function as electrodes, it is possible to reduce the influence of electrical resistance. In this case, when removing electric charges collected on the reflective films 54 and 55, it is possible to make the electric charges collected on the reflective films 54 and 55 move away easily, for example, by connecting the reflective films 54 and 55 to the wiring electrodes 58A and 58B. Therefore, it is possible to effectively suppress the charging of the reflective films 54 and 55.

In addition, in the present embodiment, the configuration has been illustrated in which the reflective films 54 and 55 are connected to the wiring electrodes 58A and 58B in order to remove electric charges collected on the reflective films 54 and 55. However, for example, the reflective films 54 and 55 may be made to function as electrodes for capacitance detection or may be made to function as driving electrodes. Even in such a case, it is possible to reduce the influence of electrical resistance by reducing the extraction length of the fixed extraction portion 54A or the movable extraction portion 55A as described above. As a result, it is possible to appropriately perform the detection of the capacitance or the application of the driving force.

In addition, since the second conductive member 57B is provided in the movable portion 521, which is hard to bend compared with the holding portion 522, it is possible to prevent the bending of the movable portion 521 and the holding portion 522 due to the internal stress of the second conductive member 57B and the like. In addition, even if an electrostatic attraction is applied between the substrates 51 and 52 by the electrostatic actuator 56, it is possible to suppress the lowering of the bending balance. As a result, light with a measurement target wavelength can be accurately extracted from the wavelength tunable interference filter 5.

In the present embodiment, the fixed reflective film 54 and the movable reflective film 55 are formed of an Ag alloy film, and the first and second conductive members 57A and 57B are formed of an ITO film. That is, the reflective films 54 and 55 are formed of a metal alloy film, and the conductive members 57A and 57B are formed of metal oxide having good adhesion to the metal film or the metal alloy film. For this reason, peeling between the reflective films 54 and 55 and the conductive members 57A and 57B is prevented.

In addition, the wiring electrodes 58A and 58B (first and second wiring electrodes 58A and 58B) are formed by the Cr layer of the base layer and the Au layer of the electrode layer, and the base layer is connected to the conductive members 57A and 58B. Therefore, since the adhesion between the wiring electrodes 58A and 58B and the conductive members 57A and 57B is improved, peeling between the wiring electrodes 58A and 58B and the conductive members 57A and 57B is also prevented.

As described above, peeling is prevented by making the electrodes of different materials overlap each other. As a result, since it is possible to further reduce the risk of disconnection, it is possible to improve the connection reliability.

In the present embodiment, the fixed electrode 561 that forms the electrostatic actuator 56 and the first conductive member 57A are formed of the same material (ITO film). Similarly, the movable electrode 562 and the second conductive member 57B are formed of the same material.

In such a configuration, as shown in FIG. 7C or 8C, the fixed electrode 561 and the first conductive member 57A can be formed simultaneously in one step, and the movable electrode 562 and the second conductive member 57B can be formed simultaneously in one step. Therefore, since it is not necessary to perform separate steps in order to form the conductive members 57A and 57B, it is possible to improve the manufacturing efficiency.

### Second Embodiment

Next, a second embodiment of the invention will be described below.

In the first embodiment described above, an example where the second conductive member 57B is provided in the movable portion 521 is shown. Meanwhile, in the second embodiment, the position where the second conductive member 57B is provided is different from that in the first embodiment.

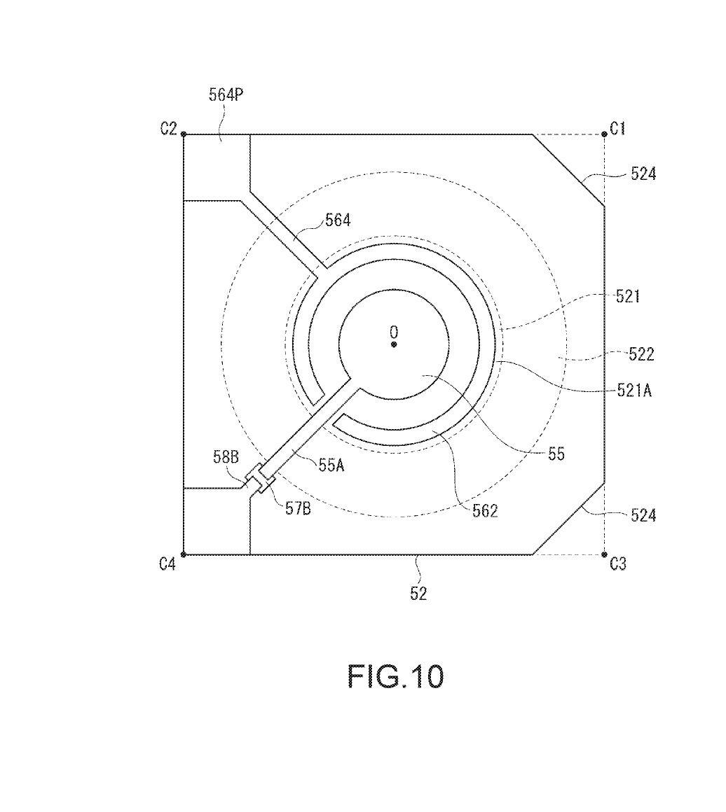

FIG. 10 is a plan view when the movable substrate 52 is viewed from the fixed substrate 51 side in the second embodiment.

As shown in FIG. 10, in the present embodiment, the second conductive member 57B is provided outside the holding portion 522, that is, in the substrate outer peripheral portion 525 in plan view. More specifically, the second conductive member 57B is provided on the line segment toward the apex C4 from the filter center point O, and faces the electrode extraction groove 511B of the fixed substrate 51.

In such a configuration, the extraction length of the movable extraction portion 55A of the movable reflective film 55 is increased. Accordingly, the electrical resistance is increased by the increase in the extraction length of the movable extraction portion 55A, but the movable portion 521 and the holding portion 522 are not influenced by the internal stress of the second conductive member 57B. That is, also in the first embodiment, the bending of the movable portion 521 or the holding portion 522 due to internal stress is suppressed by providing the second conductive member 57B in the movable portion 521. However, the holding portion 522 may be bent due to internal stress propagated from the movable portion 521 to the holding portion 522. For this reason, it is desirable to select a material with small internal stress as the second conductive member 57B. On the other hand, in the present embodiment, since the second conductive member 57B is provided outside the holding portion 522, that is, in a region fixed to the fixed substrate 51, propagation to the holding portion 522 is suppressed more reliably even if internal stress is added by the second conductive member 57B. Accordingly, since a material of the second conductive member 57B can be selected regardless of internal stress, it is possible to improve the degree of freedom in design.

### Third Embodiment

Next, a third embodiment of the invention will be described with reference to the accompanying drawings.

In the spectrometer 1 of the first embodiment described above, the wavelength tunable interference filter 5 is directly provided in the optical module 10. However, there is an optical module having a complicated configuration. In particular, it may be difficult to provide the wavelength tunable interference filter 5 directly in a small optical module. In the present embodiment, an optical filter device that enables the wavelength tunable interference filter 5 to be easily provided in such a small optical module will be described below.

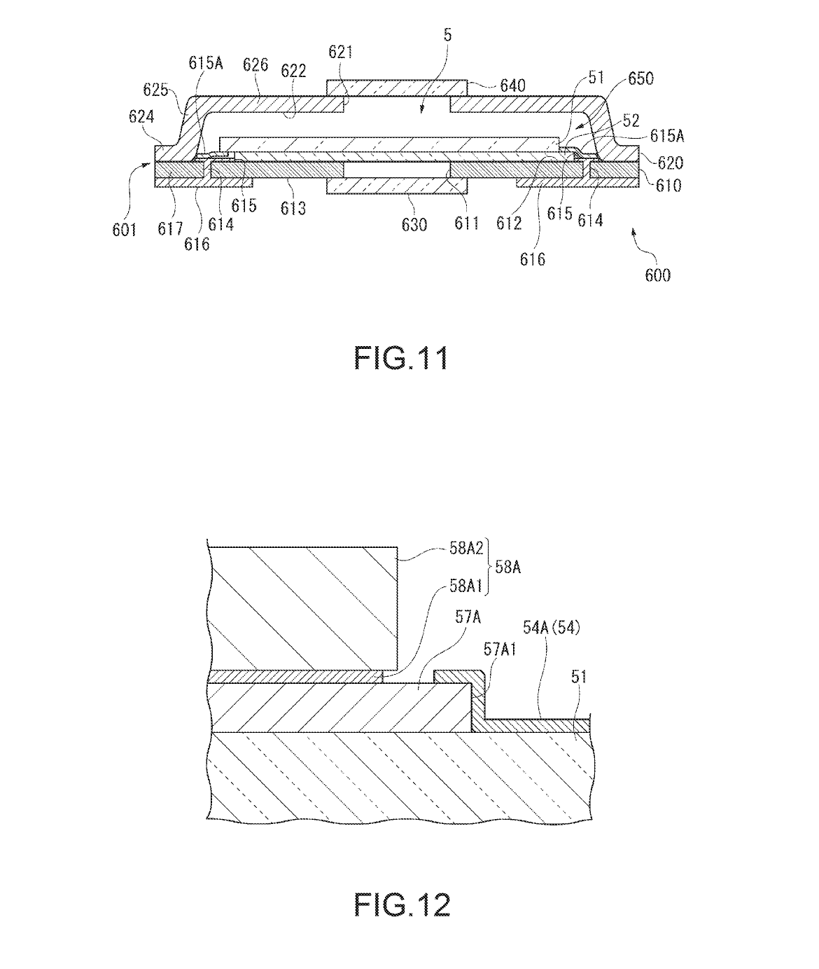

FIG. 11 is a cross-sectional view showing the schematic configuration of an optical filter device of the third embodiment of the invention.

As shown in FIG. 11, an optical filter device 600 includes the wavelength tunable interference filter 5 and a housing 601 in which the wavelength tunable interference filter 5 is housed.

The housing 601 includes a base substrate 610, a lid 620, a base side glass substrate 630, and a lid side glass substrate 640.

The base substrate 610 is formed of a single layer ceramic substrate, for example. The movable substrate 52 of the wavelength tunable interference filter 5 is provided on the base substrate 610. Regarding the arrangement of the movable substrate 52 with respect to the base substrate 610, for example, the movable substrate 52 may be disposed on the base substrate 610 with an adhesive layer interposed therebetween or may be disposed on the base substrate 610 by fitting to other fixed members. In addition, a light passing hole 611 is formed on the base substrate 610 so as to be open. In addition, the base side glass substrate 630 is bonded so as to cover the light passing hole 611. As examples of the method of bonding the base side glass substrate 630, it is possible to use a glass frit bonding method using a glass frit, which is a piece of glass obtained by dissolving a glass material at high temperature and quenching the glass material, and a bonding method using an epoxy resin or the like.

On a base inside surface 612 of the base substrate 610 facing the lid 620, an inside terminal portion 615 is provided corresponding to each of the extraction electrodes 563 and 564 of the wavelength tunable interference filter 5. In addition, connection between each of the extraction electrodes 563 and 564 and the inside terminal portion 615 can be made using, for example, FPC615A. For example, each of the extraction electrodes 563 and 564 and the inside terminal portion 615 are bonded to each other using Ag paste, an anisotropic conductive film (ACF), anisotropic conductive paste (ACP), and the like. In addition, the invention is not limited to the connection using FPC615A, and wire connection, such as wire bonding, may also be performed.

In addition, on the base substrate 610, a through hole 614 is formed corresponding to the position where each inside terminal portion 615 is provided. Each inside terminal portion 615 is connected to an outside terminal portion 616, which is provided on a base outside surface 613 of the base substrate 610 opposite the base inside surface 612, through a conductive member filled in the through hole 614.

In addition, a base bonding portion 617 bonded to the lid 620 is provided on the outer periphery of the base substrate 610.

As shown in FIG. 11, the lid 620 includes a lid bonding portion 624 bonded to the base bonding portion 617 of the base substrate 610, a side wall portion 625 that is continuous from the lid bonding portion 624 and rises in a direction away from the base substrate 610, and a top surface portion 626 that is continuous from the side wall portion 625 and covers the fixed substrate 51 side of the wavelength tunable interference filter 5. The lid 620 can be formed of, for example, metal or alloy, such as Kovar.

The lid 620 is closely bonded to the base substrate 610 since the lid bonding portion 624 and the base bonding portion 617 of the base substrate 610 are bonded to each other.

As examples of the bonding method, not only laser welding but also soldering using silver solder, sealing using an eutectic alloy layer, welding using low-melting-point glass, glass adhesion, glass frit bonding, and bonding using epoxy resin can be mentioned. These bonding methods can be appropriately selected according to the material, bonding environment, and the like of the base substrate 610 and the lid 620.

The top surface portion 626 of the lid 620 is parallel to the base substrate 610. A light passing hole 621 is formed on the top surface portion 626 so as to be open. In addition, the lid side glass substrate 640 is bonded so as to cover the light passing hole 621. As examples of the method of bonding the lid side glass substrate 640, it is possible to use a glass frit bonding method and a bonding method using an epoxy resin or the like similar to the bonding of the base side glass substrate 630.

### Operations and Effects of the Third Embodiment

In the optical filter device 600 of the present embodiment described above, since the wavelength tunable interference filter 5 is protected by the housing 601, it is possible to prevent damage to the wavelength tunable interference filter 5 due to external factors.

### Other Embodiments

In addition, the invention is not limited to the embodiments described above, but various modifications or improvements may be made without departing from the scope and spirit of the invention.

For example, in the first embodiment, as shown in FIG. 4, the configuration has been described in which the ends of the conductive members 57A and 57B (first and second conductive members 57A and 57B) are covered by the wiring electrodes 58A and 58B (first and second wiring electrodes 58A and 58B). However, the invention is not limited thereto. For example, a configuration shown in FIG. 12 may be adopted. FIG. 12 is a cross-sectional view schematically showing a connection state of the first wiring electrode 58A and the fixed reflective film 54 through the first conductive member 57A in another embodiment of the invention.

That is, as shown in FIG. 12, it is possible to adopt a configuration in which the first conductive member 57A is disposed below the first wiring electrode 58A, one end of the first conductive member 57A on the fixed reflective film 54 side protrudes toward the fixed reflective film 54 side from the first wiring electrode 58A, and the fixed reflective film 54 is provided so as to cover the protruding portion. Similarly, the second conductive member 57B may be disposed below the second wiring electrode 58B, and one end of the second conductive member 57B on the movable reflective film 55 side may protrude toward the movable reflective film 55 from the second wiring electrode 58B.

In the first embodiment described above, the configuration has been illustrated in which the first conductive member 57A is provided between the virtual circle P1 along the inner periphery of the fixed electrode 561 and the outer circumference P2 of the fixed reflective film 54. However, the invention is not limited thereto. For example, the first conductive member 57A may be provided on the outer peripheral edge of the fixed reflective film 54. In this case, since there is no need to provide the fixed extraction portion 54A with a small line width in the fixed reflective film 54, it is possible to further reduce the electrical resistance.

Similarly, the second conductive member 57B may be provided on the outer peripheral edge of the movable reflective film 55 and the movable extraction portion 55A may not be provided.

In the first and second embodiments described above, in order to make both the fixed reflective film 54 and the movable reflective film 55 function as electrodes, the first conductive member 57A and the first wiring electrode 58A are provided on the fixed substrate 51, and the second conductive member 57B and the second wiring electrode 58B are provided on the movable substrate 52. On the other hand, one of the fixed reflective film 54 and the movable reflective film 55 may be made to function as an electrode. For example, when removing the charging of only the fixed reflective film 54, neither the second conductive member 57B nor the second wiring electrode 58B may be provided on the movable substrate 52.

In addition, although the configuration in which the second conductive member 57B is provided between the virtual circle P1 and the outer circumference P2 has been illustrated in the first embodiment, the second conductive member 57B may be provided elsewhere in the movable portion 521. As described above, the holding portion 522 is formed in the shape of a diaphragm, and is a portion easily deformed by internal stress or the like. Accordingly, when providing the second conductive member 57B in the holding portion 522, it is desirable to suppress the influence of internal stress. For this reason, the degree of freedom in selecting a material of the second conductive member 57B, a method of forming the second conductive member 57B, and the like is reduced. In contrast, since the movable portion 521 is a portion that is difficult to deform due to internal stress or the like compared with the holding portion 522, the second conductive member 57B may be provided in a C-shaped opening of the movable electrode 562, for example. However, since the movable extraction portion 55A has the same thickness as the movable reflective film 55 and has a small line width as described above, this becomes a factor that increases electrical resistance. Therefore, it is preferable to form the movable extraction portion 55A as short as possible. For this reason, as described above, the configuration is preferable in which the second conductive member 57B is provided between the virtual circle P1 and the outer circumference P2 or on the outer circumference P2 of the movable reflective film 55.

In the first embodiment, the example has been illustrated in which the reflective films 54 and 55 are formed using an Ag alloy film and the conductive members 57A and 57B are formed using an ITO film that is a metal oxide. However, the invention is not limited thereto. That is, materials of the reflective films 54 and 55 and the conductive members 57A and 57B are not particularly limited if they are conductive materials allowing electrical connection between the reflective films 54 and 55 and the conductive members 57A and 57B. For example, a metal film may be formed on the reflective films 54 and 55 and the conductive members 57A and 57B.

In addition, although the example has been illustrated in which the first conductive member 57A and the fixed electrode 561 are formed of the same material and the second conductive member 57B and the movable electrode 562 are formed of the same material, the invention is not limited thereto. For example, the first conductive member 57A and the fixed electrode 561 may be formed of different materials, and the second conductive member 57B and the movable electrode 562 may be formed of different materials.

In the embodiment described above, the example has been illustrated in which the gap amount of the inter-reflective film gap is changed by the electrostatic actuator 56 formed by the fixed electrode 561 and the movable electrode 562, but the invention is not limited thereto.

For example, a dielectric actuator, which is formed by a first dielectric coil provided on the fixed substrate 51 and a second dielectric coil or a permanent magnet provided on the movable substrate 52, may be used as a gap change portion.

In addition, a piezoelectric actuator may be used instead of the electrostatic actuator 56. In this case, the holding portion 522 can be bent, for example, by laminating a lower electrode layer, a piezoelectric layer, and an upper electrode layer on the holding portion 522 and expanding and contracting the piezoelectric layer by changing the voltage, which is applied between the lower electrode layer and the upper electrode layer, as an input value.

In addition, for example, a configuration of adjusting the gap amount of the inter-reflective film gap G1 by changing the air pressure between the fixed substrate 51 and the movable substrate 52 can also be exemplified without being limited to the configuration in which the gap amount of the inter-reflective film gap G1 is changed by voltage application.

In addition, in each embodiment described above, the spectrometer 1 has been exemplified as the electronic apparatus according to the invention. However, the wavelength tunable interference filter 5, the optical module, and the electronic apparatus according to the invention can be applied in various fields.

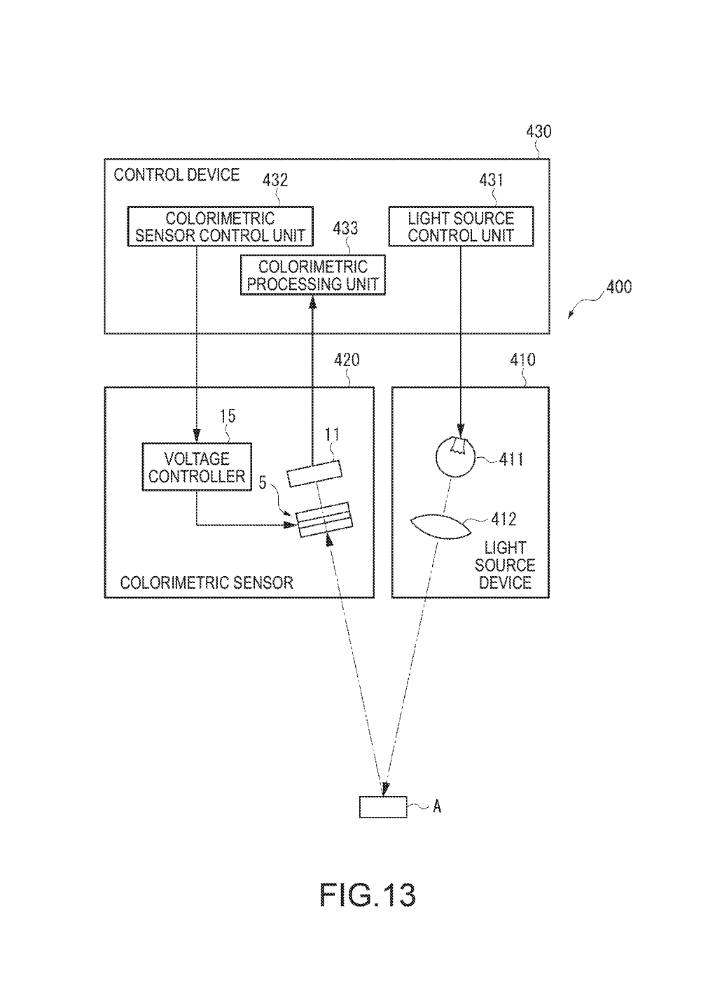

For example, as shown in FIG. 13, the electronic apparatus according to the invention can also be applied to a colorimetric apparatus for measuring color.

FIG. 13 is a block diagram showing an example of a colorimetric apparatus 400 including the wavelength tunable interference filter 5.

As shown in FIG. 13, the colorimetric apparatus 400 includes a light source device 410 that emits light to a test target A, a colorimetric sensor 420 (optical module), and a control device 430 (control unit) that controls the overall operation of the colorimetric apparatus 400. In addition, the colorimetric apparatus 400 is an apparatus that reflects light emitted from the light source device 410 by the test target A, receives the reflected light to be examined using the colorimetric sensor 420, and analyzes and measures the chromaticity of the light to be examined, that is, the color of the test target A, on the basis of a detection signal output from the colorimetric sensor 420.

The light source device 410 includes a light source 411 and a plurality of lenses 412 (only one lens is shown in FIG. 13), and emits reference light (for example, white light) to the test target A. In addition, a collimator lens may be included in the plurality of lenses 412. In this case, the light source device 410 forms the reference light emitted from the light source 411 as parallel light using the collimator lens and emits the parallel light from a projection lens (not shown) toward the test target A. In addition, although the colorimetric apparatus 400 including the light source device 410 has been illustrated in the present embodiment, the light source device 410 may not be provided, for example, when the test target A is a light emitting member, such as a liquid crystal panel.

As shown in FIG. 13, the colorimetric sensor 420 includes the wavelength tunable interference filter 5, the detector 11 that receives light transmitted through the wavelength tunable interference filter 5, and the voltage controller 15 that controls a voltage applied to the electrostatic actuator 56 of the wavelength tunable interference filter 5. In addition, the colorimetric sensor 420 includes an incident optical lens (not shown) that is provided at a position facing the wavelength tunable interference filter 5 and that guides reflected light (light to be examined), which is reflected by the test target A, to the inside. In addition, the colorimetric sensor 420 separates light with a predetermined wavelength, among light beams to be examined incident from the incident optical lens, using the wavelength tunable interference filter 5 and receives the separated light using the detector 11.

The control device 430 servers as a control unit in the embodiment of the invention, and controls the overall operation of the colorimetric apparatus 400.

As the control device 430, for example, a general-purpose personal computer, a personal digital assistant, and a computer dedicated to color measurement can be used. In addition, as shown in FIG. 13, the control device 430 is configured to include a light source control unit 431, a colorimetric sensor control unit 432, and a colorimetric processing unit 433.

The light source control unit 431 is connected to the light source device 410, and outputs a predetermined control signal to the light source device 410 on the basis of, for example, a setting input from the user so that white light with predetermined brightness is emitted from the light source device 410.

The colorimetric sensor control unit 432 is connected to the colorimetric sensor 420, and sets a wavelength of light received by the colorimetric sensor 420 on the basis of, for example, a setting input from the user and outputs to the colorimetric sensor 420 a control signal to detect the amount of received light with the wavelength. Then, the voltage controller 15 of the colorimetric sensor 420 applies a voltage to the electrostatic actuator 56 on the basis of the control signal, thereby driving the wavelength tunable interference filter 5.

The colorimetric processing unit 433 analyzes the chromaticity of the test target A from the amount of received light detected by the detector 11. In addition, as in the first and second embodiments, the colorimetric processing unit 433 may analyze the chromaticity of the test target A by estimating a spectrum S using an estimation matrix Ms with the amount of light obtained by the detector 11 as a measurement spectrum D.

In addition, as another example of the electronic apparatus of the invention, a light-based system for detecting the presence of a specific material can be mentioned. As examples of such a system, an in-vehicle gas leak detector that performs high-sensitivity detection of a specific gas by adopting a spectroscopic measurement method using the wavelength tunable interference filter 5 according to the invention or a gas detector, such as a photoacoustic rare gas detector for breast test, can be exemplified.

An example of such a gas detector will now be described with reference to the accompanying drawings.

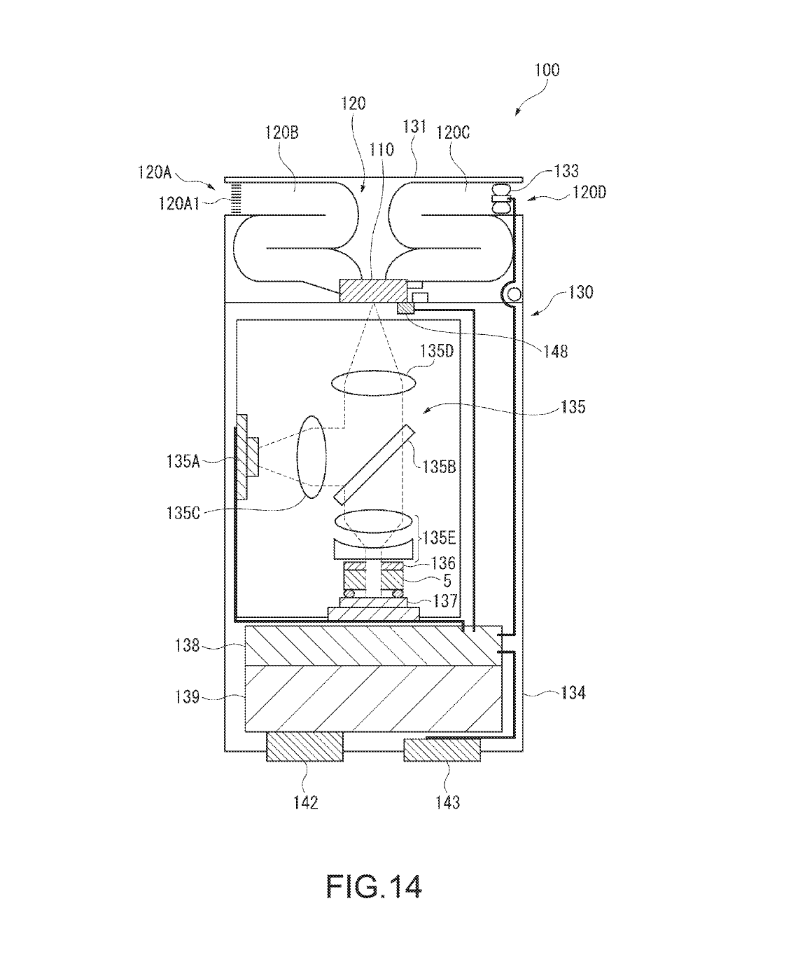

FIG. 14 is a schematic diagram showing an example of a gas detector including the wavelength tunable interference filter 5.

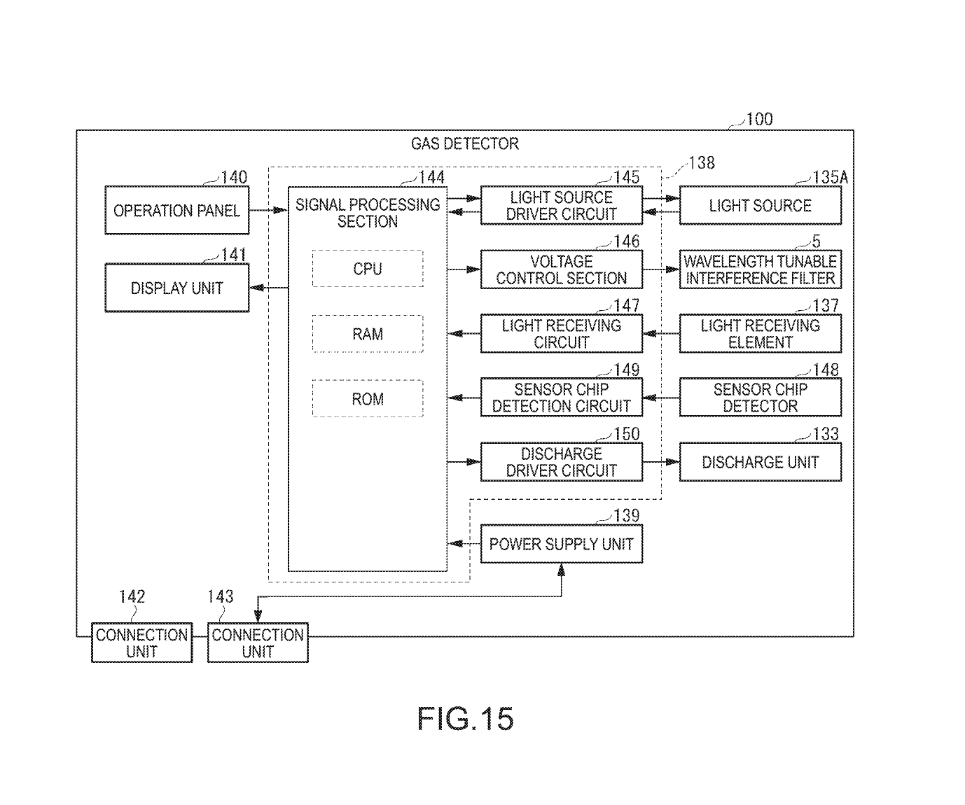

FIG. 15 is a block diagram showing the configuration of a control system of the gas detector shown in FIG. 14.

As shown in FIG. 14, a gas detector 100 is configured to include: a sensor chip 110; a flow path 120 including a suction port 120A, a suction flow path 120B, a discharge flow path 120C, and a discharge port 120D; and a main body 130.

The main body 130 is configured to include: a detection device including a sensor unit cover 131 having an opening through which the flow path 120 can be attached or detached, a discharge unit 133, a housing 134, an optical unit 135, a filter 136, the wavelength tunable interference filter 5, and a light receiving element 137 (detection unit); a control unit 138 that processes a detected signal and controls the detection unit; and a power supply unit 139 that supplies electric power. In addition, the optical unit 135 is configured to include a light source 135A that emits light, a beam splitter 135B that reflects the light incident from the light source 135A toward the sensor chip 110 side and transmits the light incident from the sensor chip side toward the light receiving element 137 side, and lenses 135C, 135D, and 135E.

In addition, as shown in FIG. 15, an operation panel 140, a display unit 141, a connection unit 142 for interface with the outside, and the power supply unit 139 are provided on the surface of the gas detector 100. When the power supply unit 139 is a secondary battery, a connection unit 143 for charging may be provided.

In addition, as shown in FIG. 15, the control unit 138 of the gas detector 100 includes a signal processing section 144 formed by a CPU or the like, a light source driver circuit 145 for controlling the light source 135A, a voltage control section 146 for controlling the wavelength tunable interference filter 5, a light receiving circuit 147 that receives a signal from the light receiving element 137, a sensor chip detection circuit 149 that reads a code of the sensor chip 110 and receives a signal from a sensor chip detector 148 that detects the presence of the sensor chip 110, and a discharge driver circuit 150 that controls the discharge unit 133. In addition, a storage unit (not shown) that stores V-λ data is provided in the gas detector 100.

Next, the operation of the above gas detector 100 will be described below.

The sensor chip detector 148 is provided inside the sensor unit cover 131 located in the upper portion of the main body 130, and the presence of the sensor chip 110 is detected by the sensor chip detector 148. When a detection signal from the sensor chip detector 148 is detected, the signal processing section 144 determines that the sensor chip 110 is mounted, and outputs a display signal to display “detection operation is executable” on the display unit 141.

Then, for example, when the operation panel 140 is operated by the user and an instruction signal indicating the start of detection processing is output from the operation panel 140 to the signal processing section 144, the signal processing section 144 first outputs a signal for operating the light source to the light source driver circuit 145 to operate the light source 135A. When the light source 135A is driven, linearly-polarized stable laser light with a single wavelength is emitted from the light source 135A. In addition, a temperature sensor or a light amount sensor is provided in the light source 135A, and the information is output to the signal processing section 144. In addition, when it is determined that the light source 135A is stably operating on the basis of the temperature or the amount of light input from the light source 135A, the signal processing section 144 operates the discharge unit 133 by controlling the discharge driver circuit 150. Then, a gas sample containing a target material (gas molecules) to be detected is guided from the suction port 120A to the suction flow path 120B, the inside of the sensor chip 110, the discharge flow path 120C, and the discharge port 120D. In addition, a dust filter 120A1 is provided on the suction port 120A in order to remove relatively large dust particles, some water vapor, and the like.

In addition, the sensor chip 110 is a sensor in which a plurality of metal nanostructures are included and which uses localized surface plasmon resonance. In such a sensor chip 110, an enhanced electric field is formed between the metal nanostructures by laser light. When gas molecules enter the enhanced electric field, Rayleigh scattered light and Raman scattered light including the information of molecular vibration are generated.

Such Rayleigh scattered light or Raman scattered light is incident on the filter 136 through the optical unit 135, and the Rayleigh scattered light is separated by the filter 136 and the Raman scattered light is incident on the wavelength tunable interference filter 5. In addition, the signal processing section 144 outputs a control signal to the voltage control section 146. Then, as shown in the first embodiment described above, the voltage control section 146 reads a voltage value corresponding to the measurement target wavelength from the storage unit, applies the voltage to the electrostatic actuator 56 of the wavelength tunable interference filter 5, and separates the Raman scattered light corresponding to gas molecules to be detected using the wavelength tunable interference filter 5. Then, when the separated light is received by the light receiving element 137, a light receiving signal corresponding to the amount of received light is output to the signal processing section 144 through the light receiving circuit 147. In this case, the target Raman scattered light can be accurately extracted from the wavelength tunable interference filter 5.

The signal processing section 144 determines whether or not the gas molecules to be detected obtained as described above are target gas molecules by comparing the spectral data of the Raman scattered light corresponding to the gas molecules to be detected with the data stored in the ROM, and specifies the material. In addition, the signal processing section 144 displays the result information on the display unit 141, or outputs the result information to the outside through the connection unit 142.

In addition, in FIGS. 14 and 15, the gas detector 100 that separates Raman scattered light using the wavelength tunable interference filter 5 and detects gas from the separated Raman scattered light has been illustrated. However, as a gas detector, it is also possible to use a gas detector that specifies the type of gas by detecting the gas-specific absorbance. In this case, a gas sensor that detects light absorbed by gas, among incident light, after making gas flow into the sensor is used as the optical module according to the invention. In addition, a gas detector that analyzes and determines gas, which flows into the sensor by the gas sensor, is used as the electronic apparatus according to the invention. In such a configuration, it is possible to detect the components of the gas using the wavelength tunable interference filter 5.

In addition, as a system for detecting the presence of a specific material, a material component analyzer, such as a non-invasive measuring apparatus for obtaining information regarding sugar using near-infrared spectroscopy or a non-invasive measuring apparatus for obtaining information regarding food, minerals, the body, and the like can be exemplified without being limited to the gas detection described above.

Hereinafter, a food analyzer will be described as an example of the material component analyzer.

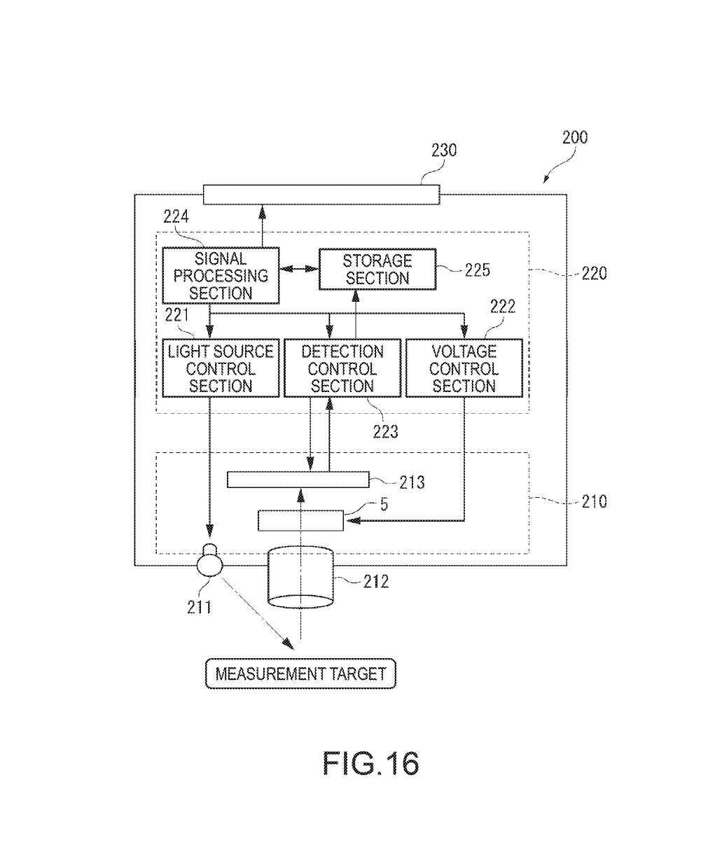

FIG. 16 is a drawing showing the schematic configuration of a food analyzer that is an example of an electronic apparatus using the wavelength tunable interference filter 5.

As shown in FIG. 16, a food analyzer 200 includes a detector 210 (optical module), a control unit 220, and a display unit 230. The detector 210 includes a light source 211 that emits light, an imaging lens 212 to which light from a measurement target is introduced, the wavelength tunable interference filter 5 that can separate the light introduced to the imaging lens 212, and an imaging section 213 (detection section) that detects the separated light.

In addition, the control unit 220 includes a light source control section 221 that performs ON/OFF control of the light source 211 and brightness control at the time of lighting, a voltage control section 222 that controls the wavelength tunable interference filter 5, a detection control section 223 that controls the imaging section 213 and acquires a spectral image captured by the imaging section 213, a signal processing section 224, and a storage section 225.

In the food analyzer 200, when the system is driven, the light source control section 221 controls the light source 211 so that light is emitted from the light source 211 to the measurement target. Then, light reflected by the measurement target is incident on the wavelength tunable interference filter 5 through the imaging lens 212. By the control of the voltage control section 222, the wavelength tunable interference filter 5 is driven according to the driving method shown in the first or second embodiment. Therefore, light with a desired wavelength can be accurately extracted from the wavelength tunable interference filter 5. In addition, the extracted light can be imaged by the imaging section 213 formed by a CCD camera, for example. In addition, the imaged light is stored in the storage section 225 as a spectral image. In addition, the signal processing section 224 changes the value of a voltage applied to the wavelength tunable interference filter 5 by controlling the voltage control section 222, thereby obtaining a spectral image for each wavelength.

Then, the signal processing section 224 calculates a spectrum in each pixel by performing arithmetic processing on the data of each pixel in each image stored in the storage section 225. In addition, for example, information regarding the components of the food for the spectrum is stored in the storage section 225. The signal processing section 224 analyzes the data of the obtained spectrum on the basis of the information regarding the food stored in the storage section 225, and calculates food components contained in the detection target and the content. In addition, food calories, freshness, and the like can be calculated from the obtained food components and content. In addition, by analyzing the spectral distribution in the image, it is possible to extract a portion, of which freshness is decreasing, in the food to be examined. In addition, it is also possible to detect foreign matter contained in the food.

Then, the signal processing section 224 performs processing for displaying the information obtained as described above, such as the components or the content of the food to be examined and the calories or freshness of the food to be examined, on the display unit 230.

In addition, although an example of the food analyzer 200 is shown in FIG. 16, the invention can also be applied to a non-invasive measuring apparatus for obtaining the information other than that described above by using substantially the same configuration. For example, the invention can be applied to a biological analyzer for the analysis of biological components involving the measurement and analysis of body fluids, such as blood. For example, if an apparatus that detects ethyl alcohol is used as the apparatus for measuring the body fluids, such as blood, the biological analyzer can be used as a drunk driving prevention apparatus that detects the drinking level of the driver. In addition, the invention can also be applied to an electronic endoscope system including such a biological analyzer.

In addition, the invention can also be applied to a mineral analyzer for analyzing the components of minerals.

In addition, the wavelength tunable interference filter, the optical module, and the electronic apparatus of the invention can be applied to the following apparatuses.

For example, it is possible to transmit data with light of each wavelength by changing the intensity of light of each wavelength with time. In this case, data transmitted by light with a specific wavelength can be extracted by separating the light with a specific wavelength using the wavelength tunable interference filter 5 provided in the optical module and receiving the light with a specific wavelength using a light receiving unit. By processing the data of light of each wavelength using an electronic apparatus including such an optical module for data extraction, it is also possible to perform optical communication.

In addition, the electronic apparatus of the invention can also be applied to a spectral camera, a spectral analyzer, and the like for capturing a spectral image by separating light using the wavelength tunable interference filter according to the invention. As an example of such a spectral camera, an infrared camera including the wavelength tunable interference filter 5 can be mentioned.

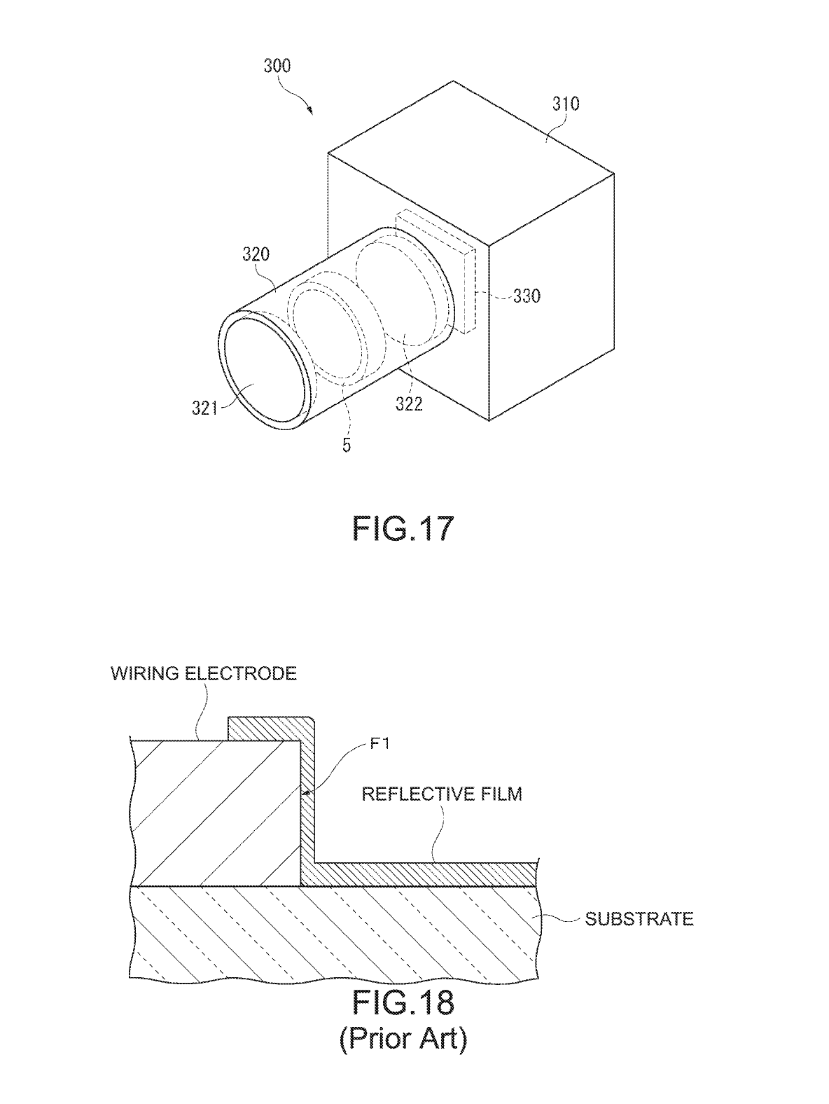

FIG. 17 is a schematic diagram showing the configuration of a spectral camera. As shown in FIG. 17, a spectral camera 300 includes a camera body 310, an imaging lens unit 320, and an imaging unit 330 (detection unit).

The camera body 310 is a portion gripped and operated by the user.

The imaging lens unit 320 is provided on the camera body 310, and guides incident image light to the imaging unit 330. In addition, as shown in FIG. 17, the imaging lens unit 320 is configured to include an objective lens 321, an imaging lens 322, and the wavelength tunable interference filter 5 provided between these lenses.

The imaging unit 330 is formed of a light receiving element, and images the image light guided by the imaging lens unit 320.

In the spectral camera 300, a spectral image of light with a desired wavelength can be captured by transmitting the light with a wavelength to be imaged using the wavelength tunable interference filter 5.

In addition, the wavelength tunable interference filter according to the invention may be used as a band pass filter. For example, the wavelength tunable interference filter according to the invention can be used as an optical laser device that separates and transmits only light in a narrow range having a predetermined wavelength at the center of light in a predetermined wavelength range emitted from a light emitting element.

In addition, the wavelength tunable interference filter according to the invention may be used as a biometric authentication device. For example, the wavelength tunable interference filter according to the invention can also be applied to authentication devices using blood vessels, fingerprints, a retina, and an iris using light in a near infrared region or a visible region.

In addition, the optical module and the electronic apparatus can be used as a concentration detector. In this case, using the wavelength tunable interference filter 5, infrared energy (infrared light) emitted from a material is separated and analyzed, and the analyte concentration in a sample is measured.

As described above, the wavelength tunable interference filter, the optical module, and the electronic apparatus according to the invention can be applied to any apparatus that separates predetermined light from incident light. In addition, since the wavelength tunable interference filter according to the invention can separate light beams with a plurality of wavelengths using one device as described above, measurement of the spectrum of a plurality of wavelengths, and detection of a plurality of components can be accurately performed. Accordingly, compared with a known apparatus that extracts a desired wavelength using a plurality of devices, it is possible to make an optical module or an electronic apparatus small. Therefore, the wavelength tunable interference filter according to the invention can be appropriately used as a portable optical device or an optical device for a vehicle, for example.

In addition, the specific structure when implementing the invention can be appropriately changed to other structures in a range where the object of the invention can be achieved.

1. A wavelength tunable interference filter, comprising:
a first substrate;
a second substrate facing the first substrate;
a first reflective film provided on the first substrate;
a second reflective film provided on the second substrate and disposed so as to face the first reflective film;
a wiring electrode provided on at least one of the first and second substrates; and
a conductive member provided on the one of the first and second substrates on which the wiring electrode is provided,
wherein one of the first and second reflective films, which is provided on the substrate on which the wiring electrode and the conductive member are provided, is connected to the wiring electrode through the conductive member by being laminated on the conductive member, and
a thickness of the conductive member is less than a thickness of the wiring electrode.

2. The wavelength tunable interference filter according to claim 1, further comprising:
a first electrode that is provided on the first substrate and that is located outside the first reflective film in a plan view; and
a second electrode that is provided on the second substrate, is located outside the second reflective film in the plan view, and faces the first electrode,
wherein the conductive member is disposed between one of the first and second electrodes, which is provided on the substrate on which the conductive member and the wiring electrode are provided, and one of the first and second reflective films, which is provided on the substrate on which the conductive member and the wiring electrode are provided, in the plan view.

3. The wavelength tunable interference filter according to claim 1,
wherein the second substrate includes a movable portion, on which the second reflective film is provided, and a holding portion, which is provided outside the movable portion in a plan view and which holds the movable portion so as to be movable back and forth with respect to the first substrate, and
the conductive member is provided on the movable portion.

4. The wavelength tunable interference filter according to claim 1,
wherein the second substrate includes a movable portion, on which the second reflective film is provided, and a holding portion, which is provided outside the movable portion in a plan view and which holds the movable portion so as to be movable back and forth with respect to the first substrate, and
the conductive member is provided outside the holding portion of the second substrate in the plan view.

5. The wavelength tunable interference filter according to claim 1,
wherein the first and second reflective films are formed of a metal film or a metal alloy film, and
the conductive member is formed of a metal oxide film.

6. The wavelength tunable interference filter according to claim 1, further comprising:
a first electrode that is provided on the first substrate and that is located outside the first reflective film in a plan view; and
a second electrode that is provided on the second substrate, is located outside the second reflective film in the plan view, and faces the first electrode,
wherein the conductive member is formed of the same material as one of the first and second electrodes which is provided on the substrate on which the conductive member and the wiring electrode are provided.

7. The wavelength tunable interference filter according to claim 1,
wherein the conductive member has a thickness of 15 nm to 150 nm.

8. An optical filter device, comprising:
the wavelength tunable interference filter according to claim 1; and
a housing in which the wavelength tunable interference filter is housed.

9. An optical filter device, comprising:
the wavelength tunable interference filter according to claim 2; and
a housing in which the wavelength tunable interference filter is housed.

10. An optical module, comprising:
the wavelength tunable interference filter according to claim 1; and
a detection unit that detects light extracted by the first and second reflective films.

11. An optical module, comprising:
the wavelength tunable interference filter according to claim 2; and
a detection unit that detects light extracted by the first and second reflective films.

12. An electronic apparatus, comprising:
the wavelength tunable interference filter according to claim 1; and
a control unit that controls application of a voltage to the wiring electrode.

13. An electronic apparatus, comprising:
the wavelength tunable interference filter according to claim 2; and
a control unit that controls application of a voltage to the wiring electrode.

14. A wavelength tunable interference filter, comprising:
a substrate;
a reflective film that is provided on the substrate and has conductivity;
a wiring electrode that is provided on the substrate and is disposed at a position spaced apart from the reflective film; and
a conductive member that is provided on the substrate and is provided between the reflective film and the wiring electrode,
wherein the reflective film is connected to the wiring electrode through the conductive member by being laminated on the conductive member, and
a thickness of the conductive member is less than a thickness of the wiring electrode.

15. A wavelength tunable interference filter, comprising:
a first substrate;
a second substrate facing the first substrate;
a first partial reflective film on the first substrate;
a second partial reflective film on the second substrate and facing the first reflective film;
a wiring electrode on the first substrate; and
a conductive member on the first substrate,
wherein the first reflective film is electrically connected to the wiring electrode by being laminated onto the conductive member, and
the conductive member is thinner than the wiring electrode.

16. The wavelength tunable interference filter according to claim 15, further comprising:
a first electrode on the first substrate; and
a second electrode on the second substrate and facing the first electrode,
wherein the conductive member is disposed between the first electrode and the first reflective film in a plan view.

17. The wavelength tunable interference filter according to claim 15, further comprising:
a first electrode on the first substrate; and
a second electrode on the second substrate and facing the first electrode,
wherein the conductive member is formed of the same material as the first.

18. The wavelength tunable interference filter according to claim 15,
wherein the conductive member is 15 nm to 150 nm thick.
